(19) United States
(12) Patent Application Publication
(10) Pub. No.: US 2026/0017261 A1
(43) Pub. Date: Jan. 15, 2026

(54) Adaptive Random Access System with Learned Query Optimization for Compacted Data Files

(71) Applicant: AtomBeam Technologies Inc., Moraga, CA (US)

(72) Inventors: Joshua Cooper, Columbia, SC (US); Charles Yeomans, Orinda, CA (US)

(21) Appl. No.: 19/331,172

(22) Filed: Sep. 17, 2025

Related U.S. Application Data
(63) Continuation-in-part of application No. 18/516,924, filed on Nov. 21, 2023, now Pat. No. 12,423,270.

(51) Int. Cl. G06F 16/2453

(52) U.S. Cl. CPC G06F 16/24542

(57) ABSTRACT

An adaptive random access system and method with learned query optimization for compacted data files that enhances random access performance through machine learning and pattern recognition. The system incorporates a query pattern learning module that analyzes historical access patterns and user behavior to build statistical models of data usage. An adaptive estimator module improves location estimation accuracy by incorporating learned patterns rather than relying solely on mathematical calculations. A predictive boundary detector uses learned codeword patterns to more accurately identify boundaries in compacted data, reducing misalignment errors. An intelligent search engine coordinates optimization strategies including context-aware search string parsing and encoding strategy selection based on learned performance data. A dynamic codebook optimizer reorganizes sourceblock layout based on access frequencies and co-occurrence patterns to improve retrieval speed. An enhanced search cache implements predictive caching algorithms that anticipate user queries and proactively load relevant data.

### CROSS-REFERENCE TO RELATED APPLICATIONS

Priority is claimed in the application data sheet to the following patents or patent applications, each of which is expressly incorporated herein by reference in its entirety: Ser. No. 18/516,924

### BACKGROUND OF THE INVENTION

### Field of the Invention

The present invention is in the field of computer data storage and transmission, and in particular to adaptive random access systems that utilize machine learning and pattern recognition to optimize manipulation of compacted data files through learned query optimization.

### Discussion of the State of the Art

Global data storage demand has exceeded manufacturing capacity for physical storage devices, driving development of advanced data compression techniques. However, traditional compression methods suffer from a fundamental limitation: compressed data cannot be accessed randomly without first decompressing the entire dataset, creating significant performance bottlenecks for applications requiring selective data access.

Recent advances have introduced systems that enable random access to compacted data files without requiring full decompression. These systems utilize reference codebooks, sourceblocks, and specialized access engines that can locate and retrieve specific portions of compacted files directly. While these systems represent significant improvements over conventional compression, they rely on basic algorithmic approaches that do not adapt to usage patterns or leverage information about user behavior and data characteristics.

Current random access systems use simple mathematical estimation for determining data locations, static frequency analysis for detecting structural boundaries, and uniform search strategies regardless of query characteristics or historical performance. Real-world deployment reveals that user access patterns exhibit strong predictability with clear temporal, spatial, and behavioral correlations. Users frequently access related data in consistent sequences, show preferences for certain content types, and follow recurring workflows that suggest future data requirements.

Existing systems suffer from performance limitations including variable location estimation accuracy that often requires extensive searching operations, boundary detection failures for complex data patterns, and reactive operation that processes each query independently without anticipating user needs. When caching mechanisms are present, they employ simple replacement policies that do not incorporate predictive information about future access patterns.

Modern applications require not only random access capability but also the responsiveness and efficiency that comes from intelligent system optimization.

What is needed is an adaptive random access system that incorporates machine learning to continuously optimize performance based on observed usage patterns, providing intelligent location estimation, predictive boundary detection, adaptive search strategies, proactive caching, and dynamic optimization of compacted data organization while maintaining compatibility with existing infrastructure.

### SUMMARY OF THE INVENTION

The inventor has conceived and reduced to practice, an adaptive random access system and method with learned query optimization for compacted data files that enhances random access performance through machine learning and pattern recognition. The system incorporates a query pattern learning module that analyzes historical access patterns and user behavior to build statistical models of data usage. An adaptive estimator module improves location estimation accuracy by incorporating learned patterns rather than relying solely on mathematical calculations. A predictive boundary detector uses learned codeword patterns to more accurately identify boundaries in compacted data, reducing misalignment errors. An intelligent search engine coordinates optimization strategies including context-aware search string parsing and encoding strategy selection based on learned performance data. A dynamic codebook optimizer reorganizes sourceblock layout based on access frequencies and co-occurrence patterns to improve retrieval speed. An enhanced search cache implements predictive caching algorithms that anticipate user queries and proactively load relevant data.

According to a preferred embodiment, a system for adaptive random access with learned query optimization for compacted data files is disclosed, comprising: a computing device comprising a memory, a processor, and a non-volatile data storage device; a learned access pattern store comprising data representing historical query patterns and user behavior models; a random access engine comprising a plurality of programming instructions stored in the memory and operating on the processor, wherein the plurality of programming instructions, when operating on the processor, cause the computing device to: receive a data search query for a compacted data file; retrieve learned pattern data from the learned access pattern store corresponding to the data search query; optimize at least one random access parameter based on the learned pattern data; and execute the data search query using the optimized random access parameter to locate data within the compacted data file; and a learning feedback system comprising a plurality of programming instructions stored in the memory and operating on the processor, wherein the plurality of programming instructions, when operating on the processor, cause the computing device to: monitor query execution results; and update the learned access pattern store based on the query execution results.

According to another preferred embodiment, a method for adaptive random access with learned query optimization for compacted data files is disclosed, comprising the steps of: receiving a data search query for a compacted data file; retrieving learned pattern data from a learned access pattern store corresponding to the data search query; optimizing at least one random access parameter based on the learned pattern data; executing the data search query using the optimized random access parameter to locate data within the compacted data file; monitoring query execution results; and updating the learned access pattern store based on the query execution results.

According to a further aspect, the method includes calculating a base mathematical estimate for a location hint in the data search query; retrieving pattern-based adjustment factors from the learned access pattern store based on similar historical queries; and generating an optimized location estimate by combining the base mathematical estimate with the pattern-based adjustment factors.

According to a further aspect, the method includes analyzing bit sequences at an estimated location using learned codeword pattern models from the learned access pattern store; applying statistical pattern matching to identify codeword boundaries; and outputting refined boundary locations with associated confidence scores.

According to a further aspect, the method includes at least one random access parameter comprising search strategy selection, and further comprising the steps of: analyzing characteristics of the data search query; retrieving historical success rates for different search strategies from the learned access pattern store; and selecting an optimal search strategy based on the query characteristics and historical success rates.

According to a further aspect, the method includes analyzing sourceblock access frequencies from the learned access pattern store; identifying frequently accessed sourceblocks based on access frequency thresholds; and reorganizing a reference codebook by relocating the frequently accessed sourceblocks to positions that minimize access latency.

According to a further aspect, the method includes implementing hierarchical reference codes by assigning shorter reference codes to the frequently accessed sourceblocks based on actual access patterns.

According to a further aspect, the method includes generating predictions of likely future queries based on current query context and learned access patterns; calculating confidence scores for the predictions; and proactively loading predicted data when system resources permit.

According to a further aspect, the method includes learned pattern data comprising: user behavior patterns indicating query sequences and preferences; temporal access patterns indicating time-based variations in data access; and co-occurrence data indicating which data elements are frequently accessed together.

According to a further aspect, the method includes tracking prediction accuracy for optimized random access parameters; applying temporal decay weighting to emphasize recent query patterns over historical data; and validating learning results against system performance metrics before updating the learned access pattern store.

According to a further aspect, the method includes optimizing at least one random access parameter comprising optimizing multiple random access parameters simultaneously, including location estimation accuracy, boundary detection precision, and search strategy effectiveness.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a diagram showing an embodiment of the system in which all components of the system are operated locally.

FIG. 2 is a diagram showing an embodiment of one aspect of the system, the data deconstruction engine.

FIG. 3 is a diagram showing an embodiment of one aspect of the system, the data reconstruction engine.

FIG. 4 is a diagram showing an embodiment of one aspect of the system, the library management module.

FIG. 5 is a diagram showing another embodiment of the system in which data is transferred between remote locations.

FIG. 6 is a diagram showing an embodiment in which a standardized version of the sourceblock library and associated algorithms would be encoded as firmware on a dedicated processing chip included as part of the hardware of a plurality of devices.

FIG. 7 is a diagram showing an example of how data might be converted into reference codes using an aspect of an embodiment.

FIG. 8 is a method diagram showing the steps involved in using an embodiment to store data.

FIG. 9 is a method diagram showing the steps involved in using an embodiment to retrieve data.

FIG. 10 is a method diagram showing the steps involved in using an embodiment to encode data.

FIG. 11 is a method diagram showing the steps involved in using an embodiment to decode data.

FIG. 12 is a diagram showing an exemplary system architecture, according to a preferred embodiment of the invention.

FIG. 13 is a diagram showing a more detailed architecture for a customized library generator.

FIG. 14 is a diagram showing a more detailed architecture for a library optimizer.

FIG. 15 is a diagram showing a more detailed architecture for a transmission and storage engine.

FIG. 16 is a method diagram illustrating key system functionality utilizing an encoder and decoder pair.

FIG. 17 is a method diagram illustrating possible use of a hybrid encoder/decoder to improve the compression ratio.

FIG. 18 is a flow diagram illustrating the use of a data encoding system used to recursively encode data to further reduce data size.

FIG. 19 is an exemplary system architecture of a data encoding system used for cyber security purposes.

FIG. 20 is a flow diagram of an exemplary method used to detect anomalies in received encoded data and producing a warning.

FIG. 21 is a flow diagram of a data encoding system used for Distributed Denial of Service (DDOS) attack denial.

FIG. 22 is an exemplary system architecture of a data encoding system used for data mining and analysis purposes.

FIG. 23 is a flow diagram of an exemplary method used to enable high-speed data mining of repetitive data.

FIG. 24 is an exemplary system architecture of a data encoding system used for remote software and firmware updates.

FIG. 25 is a flow diagram of an exemplary method used to encode and transfer software and firmware updates to a device for installation, for the purposes of reduced bandwidth consumption.

FIG. 26 is an exemplary system architecture of a data encoding system used for large-scale software installation such as operating systems.

FIG. 27 is a flow diagram of an exemplary method used to encode new software and operating system installations for reduced bandwidth required for transference.

FIG. 28 is an exemplary system architecture of a data encoding system with random access capabilities.

FIG. 29 is a diagram showing an embodiment of one aspect of the system, the random access engine.

FIG. 30 is a flow diagram of an exemplary method used to search and read data from a compacted data file.

FIG. 31 is a flow diagram of an exemplary method used to write data to a compacted data file.

FIG. 32 is a diagram showing an example of how data might be converted into reference codes, how the converted data randomly accessed may result in incorrect output, and how correct data may be located, according to an embodiment.

FIG. 33 is a diagram showing an exemplary process of parsing a search string using multiple encodings, according to an embodiment.

FIG. 34 is an exemplary system architecture of an adaptive random access system with learned query optimization capabilities, according to an embodiment.

FIG. 35 is a flow diagram illustrating an exemplary method for adaptive location estimation that enhances the functionality of adaptive estimator module, according to an embodiment.

FIG. 36 is a flow diagram illustrating an exemplary method for predictive boundary detection that enhances the functionality of predictive boundary detector within intelligent search engine, according to an embodiment.

FIGS. 37A and 37B present a flow diagram illustrating an exemplary method for query pattern learning that enables query pattern learning module to continuously analyze and learn from query execution data to improve system performance, according to an embodiment.

FIGS. 38A and 38B present a flow diagram illustrating an exemplary method for dynamic codebook optimization that enables dynamic codebook optimizer within adaptive codebook manager to reorganize the reference codebook structure based on learned access patterns to improve system performance, according to an embodiment.

FIG. 39 is a flow diagram illustrating an exemplary method for enhanced search cache management that enables enhanced search cache to implement predictive caching algorithms that anticipate user queries and proactively load relevant data to improve system response times, according to an embodiment.

FIG. 40 illustrates an exemplary computing environment on which an embodiment described herein may be implemented.

### DETAILED DESCRIPTION OF THE INVENTION

The inventor has conceived and reduced to practice an adaptive random access system and method with learned query optimization for compacted data files that enhances random access performance through machine learning and pattern recognition. The system incorporates a query pattern learning module that analyzes historical access patterns and user behavior to build statistical models of data usage. An adaptive estimator module improves location estimation accuracy by incorporating learned patterns rather than relying solely on mathematical calculations. A predictive boundary detector uses learned codeword patterns to more accurately identify boundaries in compacted data, reducing misalignment errors. An intelligent search engine coordinates optimization strategies including context-aware search string parsing and encoding strategy selection based on learned performance data. A dynamic codebook optimizer reorganizes sourceblock layout based on access frequencies and co-occurrence patterns to improve retrieval speed. An enhanced search cache implements predictive caching algorithms that anticipate user queries and proactively load relevant data.

A data search query may be generated by a system user. The data search query may include a search term, an identified compacted data file to read from, and a location hint. For instance, a user may search for a string in a text file and specify the location in the original file where the user thinks the string may be located. For example, a user data read query may be of the form: “search for the word ‘cosmology’ starting at the 50% mark of compacted version of an astrophysics textbook”. The system may use the location hint “50% mark” as a starting point for conducting a search of the encoded version of “cosmology” within the compacted version. The location hint may reference any point in the original data file, and the system may access the compacted data file at a point at or near the reference point contained within the location hint. In this way, any bit contained within a compacted data file may be randomly-accessed directly without the need to scan through or decode the entire compacted file. When the correct encodings are found, the reference codes are retrieved and a reference codebook may be used to transform the encoded version back to the original data, and the data may be sent to the user for verification.

Additionally, the system may support data write functions. A data write process begins when the system receives a data write query which may contain data the be inserted (write term) and a compacted data file to be written to. The system may re-encode the entire original data file with the inclusion of the inserted data. In other embodiments, an opcode representing an offset may be generated to facilitate a data write function that does not require re-encoding the entire data file, or unused bits located within the codebook can be used to create secondary encodings, which also does not require re-encoding the entire data file.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

The term “bit” refers to the smallest unit of information that can be stored or transmitted. It is in the form of a binary digit (either 0 or 1). In terms of hardware, the bit is represented as an electrical signal that is either off (representing 0) or on (representing 1).

The term “byte” refers to a series of bits exactly eight bits in length.

The terms “compression” and “deflation” as used herein mean the representation of data in a more compact form than the original dataset. Compression and/or deflation may be either “lossless”, in which the data can be reconstructed in its original form without any loss of the original data, or “lossy” in which the data can be reconstructed in its original form, but with some loss of the original data.

The terms “compression factor” and “deflation factor” as used herein mean the net reduction in size of the compressed data relative to the original data (e.g., if the new data is 70% of the size of the original, then the deflation/compression factor is 30% or 0.3.)

The terms “compression ratio” and “deflation ratio”, and as used herein all mean the size of the original data relative to the size of the compressed data (e.g., if the new data is 70% of the size of the original, then the deflation/compression ratio is 70% or 0.7.)

The term “data” means information in any computer-readable form. The term “sourceblock” refers to a series of bits of a specified length. The number of bits

in a sourceblock may be dynamically optimized by the system during operation. In one aspect, a sourceblock may be of the same length as the block size used by a particular file system, typically 512 bytes or 4,096 bytes.

A “database” or “data storage subsystem” (these terms may be considered substantially synonymous), as used herein, is a system adapted for the long-term storage, indexing, and retrieval of data, the retrieval typically being via some sort of querying interface or language. “Database” may be used to refer to relational database management systems known in the art, but should not be considered to be limited to such systems. Many alternative database or data storage system technologies have been, and indeed are being, introduced in the art, including but not limited to distributed non-relational data storage systems such as Hadoop, column-oriented databases, in-memory databases, and the like. While various aspects may preferentially employ one or another of the various data storage subsystems available in the art (or available in the future), the invention should not be construed to be so limited, as any data storage architecture may be used according to the aspects. Similarly, while in some cases one or more particular data storage needs are described as being satisfied by separate components (for example, an expanded private capital markets database and a configuration database), these descriptions refer to functional uses of data storage systems and do not refer to their physical architecture. For instance, any group of data storage systems of databases referred to herein may be included together in a single database management system operating on a single machine, or they may be included in a single database management system operating on a cluster of machines as is known in the art. Similarly, any single database (such as an expanded private capital markets database) may be implemented on a single machine, on a set of machines using clustering technology, on several machines connected by one or more messaging systems known in the art, or in a master/slave arrangement common in the art. These examples should make clear that no particular architectural approaches to database management is preferred according to the invention, and choice of data storage technology is at the discretion of each implementer, without departing from the scope of the invention as claimed.

The term “effective compression” or “effective compression ratio” refers to the additional amount data that can be stored using the method herein described versus conventional data storage methods. Although the method herein described is not data compression, per se, expressing the additional capacity in terms of compression is a useful comparison.

The term “data set” refers to a grouping of data for a particular purpose. One example of a data set might be a word processing file containing text and formatting information.

The term “library” refers to a database containing sourceblocks each with a pattern of bits and reference code unique within that library. The term “codebook” is synonymous with the term library.

The term “codeword” refers to a reference code form in which data is stored or transmitted in an aspect of the system. A codeword consists of a reference code or “codeword” to a sourceblock in the library plus an indication of that sourceblock's location in a particular data set.

### Conceptual Architecture

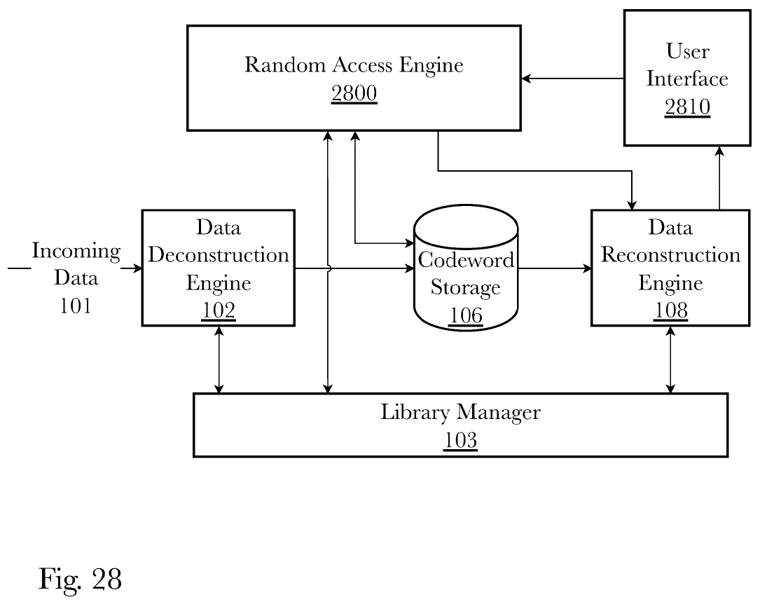

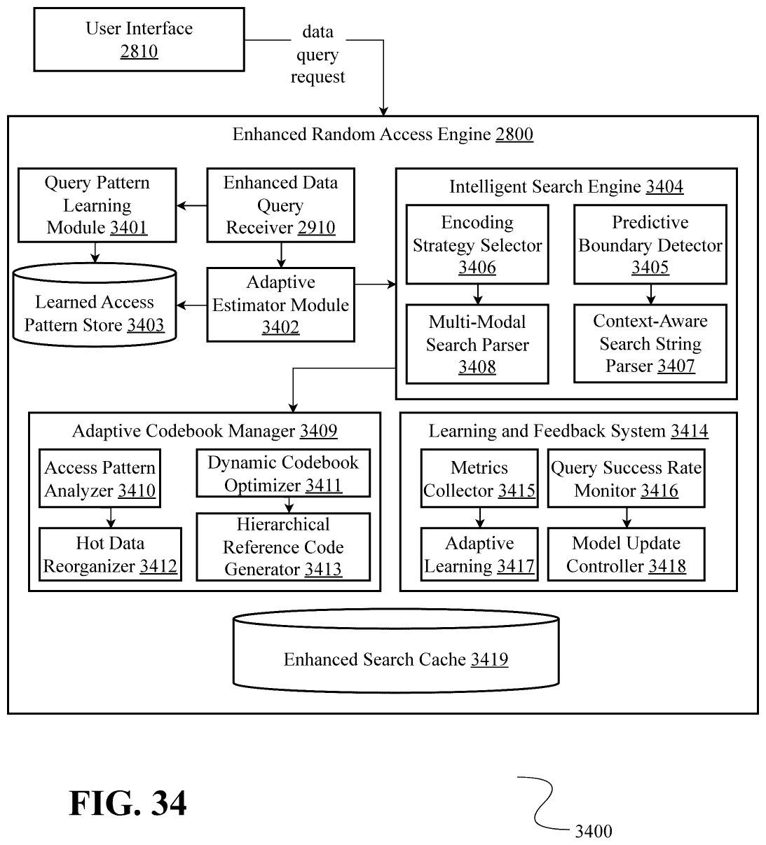

FIG. 34 is an exemplary system architecture of an adaptive random access system with learned query optimization capabilities 3400, according to an embodiment. The system extends the random access engine 2800 disclosed in FIG. 28 by incorporating machine learning and adaptive optimization components that learn from query patterns and system performance to improve random access efficiency and accuracy. The system receives, retrieves, or otherwise obtains data query requests from a user interface 2810 and processes them through an enhanced random access engine that utilizes learned patterns and intelligent optimization strategies to provide faster and more accurate data retrieval from compacted data files.

Enhanced random access engine 2800 comprises several interconnected learning and optimization modules. A query pattern learning module 3401 analyzes historical query patterns submitted through the enhanced data query receiver 2910, identifying common search sequences, user behavior patterns, and optimal search strategies for different query types. Query pattern learning module 3401 continuously monitors incoming data queries to build statistical models of access behavior, temporal patterns, and query characteristics that inform other system components. Query patterns and learned behaviors are stored in a learned access pattern store 3403, which serves as a repository for statistical models of data access frequencies, temporal patterns, user-specific behaviors, and optimization strategies that can be accessed by other system components to improve performance.

An adaptive estimator module 3402 enhances the functionality of the original estimator module 2920 by incorporating learned patterns to improve initial location estimates within compacted data files. Rather than relying solely on basic mathematical estimation, adaptive estimator module 3402 uses historical query success data, content type awareness, and learned access patterns to provide more accurate starting locations for data searches. Adaptive estimator module 3402 receives location hints from data queries and combines them with learned pattern data from learned access pattern store 3403 to generate optimized location estimates that reduce the need for extensive boundary searching and improve overall search efficiency.

The system comprises an intelligent search engine 3404 that coordinates and optimizes all search operations within the compacted data file. Intelligent search engine 3404 serves as an enhanced version of data search engine 2940 and orchestrates multiple specialized search optimization components to improve search accuracy and speed. A predictive boundary detector 3405 within intelligent search engine 3404 uses learned codeword patterns and statistical models to predict codeword boundaries more accurately than traditional frequency table methods. Predictive boundary detector 3405 analyzes historical boundary detection success rates and learns to recognize patterns that indicate proper codeword alignment, reducing incorrect boundary alignments that can lead to invalid search results.

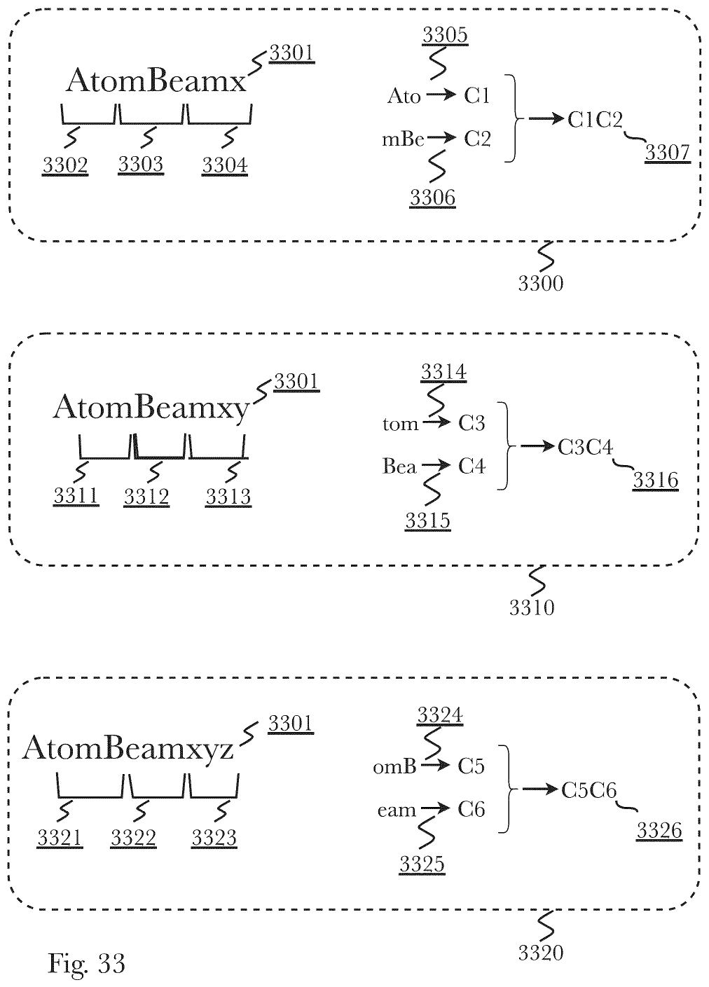

An encoding strategy selector 3406 within intelligent search engine 3404 chooses optimal encoding strategies based on data characteristics and learned performance patterns. Rather than attempting multiple encoding combinations as described in FIG. 33, encoding strategy selector 3406 uses learned data about which encoding approaches work best for specific content types, data structures, and query patterns to select the most likely successful encoding strategy first. This reduces computational overhead and improves search response times by avoiding unnecessary encoding attempts.

A context-aware search string parser 3407 enhances the search string parsing functionality described herein by incorporating content understanding and learned optimization strategies. Context-aware search string parser 3407 analyzes the structure and characteristics of search strings and uses learned patterns to optimize sourceblock alignment and encoding selection. Context-aware search string parser 3407 understands data types, content structure, and historical search patterns to make intelligent decisions about how to segment and encode search strings for optimal matching within the compacted data file.

A multi-modal search parser 3408 handles different search modalities including byte ranges, text strings, binary patterns, and structured data queries. Multi-modal search parser 3408 selects appropriate search strategies based on query type and learned performance data, optimizing the search approach for the specific characteristics of each query. Multi-modal search parser 3408 integrates multiple search strategies and learns which approaches work best for different types of searches and data content.

According to an embodiment, the system comprises an adaptive codebook manager 3409 that dynamically optimizes the organization and structure of the reference codebook based on learned access patterns and system performance. An access pattern analyzer 3410 within adaptive codebook manager 3409 continuously monitors which sourceblocks are accessed together, identifies hot data and cold data patterns, tracks temporal access trends, and analyzes user behavior to provide optimization recommendations. Access pattern analyzer 3410 builds statistical models of sourceblock co-access patterns, frequency distributions, and temporal variations that inform codebook reorganization decisions.

A dynamic codebook optimizer 3411 reorganizes the codebook layout based on access pattern analysis to improve access speed while maintaining storage efficiency. Dynamic codebook optimizer 3411 repositions frequently accessed sourceblocks to optimal locations within the codebook, creates fast-access zones for hot data, and balances individual query performance with overall system efficiency. Dynamic codebook optimizer 3411 maintains backward compatibility during reorganization to ensure existing reference codes remain valid while implementing performance improvements.

A hot data reorganizer 3412 specifically manages the placement and organization of frequently accessed sourceblocks within the codebook. Hot data reorganizer 3412 identifies sourceblocks that are accessed frequently or in predictable patterns and moves them to positions that minimize access latency. Hot data reorganizer 3412 implements intelligent caching strategies and creates optimized data layouts that improve both individual query performance and aggregate system throughput.

A hierarchical reference code generator 3413 creates multi-level reference code structures that assign shorter, more efficient codes to frequently accessed sourceblocks. Hierarchical reference code generator 3413 implements adaptive Huffman coding techniques that evolve based on actual access patterns rather than static frequency analysis. Hierarchical reference code generator 3413 maintains coding efficiency while enabling faster access to commonly requested data by dynamically adjusting code lengths based on learned usage patterns. According to an embodiment, the system incorporates a comprehensive learning

feedback system 3414 that coordinates all learning activities and manages feedback loops between system components. A performance metrics collector 3415 tracks key performance indicators including, but not limited to, access latency, cache hit rates, search success rates, boundary detection accuracy, encoding efficiency, and user satisfaction metrics. Performance metrics collector 3415 provides real-time data about system performance that feeds into learning algorithms and optimization processes.

A query success rate monitor 3416 specifically tracks the accuracy of prediction algorithms and search strategies, monitoring location estimate accuracy, search success rates for different encoding strategies, boundary detection performance, and overall system responsiveness. Query success rate monitor 3416 identifies patterns in system failures and successes that inform learning algorithm improvements and optimization strategy adjustments.

In some aspects, an adaptive learning algorithm 3417 implements online learning techniques that continuously improve system performance based on real-time feedback. Adaptive learning algorithm 3417 updates prediction models, adjusts optimization strategies, and refines search approaches based on performance data collected during system operation. Adaptive learning algorithm 3417 balances exploration of new optimization strategies with exploitation of proven successful methods to ensure continuous improvement without sacrificing system stability.

A model update controller 3418 coordinates the deployment of learning algorithm improvements across all system components. Model update controller 3418 ensures that model updates are applied consistently, manages version control for learning models, and implements rollback procedures in case updated models perform worse than previous versions. Model update controller 3418 maintains system stability during learning updates and ensures that improvements in one component do not negatively impact other system functions.

The system includes an enhanced search cache 3419 that improves upon the original search cache 2960 by implementing predictive caching algorithms that pre-load likely query results based on learned access patterns. Enhanced search cache 3419 uses intelligent cache replacement policies that consider both recency and predicted future access probability, adapts cache size and strategy based on learned usage patterns, and implements proactive caching that anticipates user needs before queries are submitted.

Adaptive random access system 3400 maintains integration with existing system components including reference codebook, codeword storage, and data reconstruction engine. The learned optimizations enhance the performance of these existing components without requiring changes to their fundamental architecture or functionality. The system provides improved random access capabilities that build upon the systems and methods described herein while delivering significantly enhanced performance through intelligent learning and adaptation mechanisms. When a data retrieval request is processed, the system applies all learned optimizations to provide faster, more accurate access to compacted data while maintaining full compatibility with original random access architecture.

As an exemplary use case, consider a large financial services organization that maintains a compressed data warehouse containing millions of customer transaction records, regulatory reports, and market analysis documents stored using the compacted data file system. During quarterly regulatory reporting periods, compliance analysts typically access related sets of documents in predictable patterns, first retrieving customer account summaries, then accessing corresponding transaction histories, followed by related regulatory filing templates. Query pattern learning module 3401 observes these access sequences over multiple reporting cycles and builds statistical models identifying that when analysts search for account summary documents containing specific customer identifiers, they subsequently access transaction records from the same time periods with 85% probability. Adaptive estimator module 3402 learns that regulatory documents are typically organized chronologically within compacted files and uses this knowledge to improve initial location estimates when analysts search for documents from specific reporting periods. When a compliance analyst submits a query searching for “customer account 12345 Q3 transactions,” intelligent search engine 3404 applies learned patterns to predict that the analyst will likely next search for related compliance documents and market analysis reports. Predictive boundary detector 3405 uses learned codeword patterns specific to financial data formats to more accurately identify sourceblock boundaries, reducing boundary misalignment errors that previously required manual bit-scrolling corrections. Context-aware search string parser 3407 recognizes that the search string contains a customer identifier and date range, applying specialized parsing strategies learned from previous financial queries to optimize sourceblock alignment. Access pattern analyzer 3410 identifies that customer account documents and their associated transaction records are frequently accessed together and recommends to dynamic codebook optimizer 3411 that these related sourceblocks be positioned adjacently within the codebook structure. Hot data reorganizer 3412 moves frequently accessed regulatory template documents to fast-access zones within the codebook, reducing access latency during high-volume reporting periods. Enhanced search cache 3419 proactively loads related compliance documents based on learned access patterns, so when the analyst's predicted subsequent queries arrive, the required data is already cached and immediately available. Performance metrics collector 3415 tracks that query response times improve by 60% during reporting periods and boundary detection accuracy increases to 95%, while query success rate monitor 3416 observes that follow-up query predictions achieve 80% accuracy, enabling adaptive learning algorithm 3417 to continuously refine the system's understanding of financial data access patterns and further optimize performance for future regulatory reporting cycles.

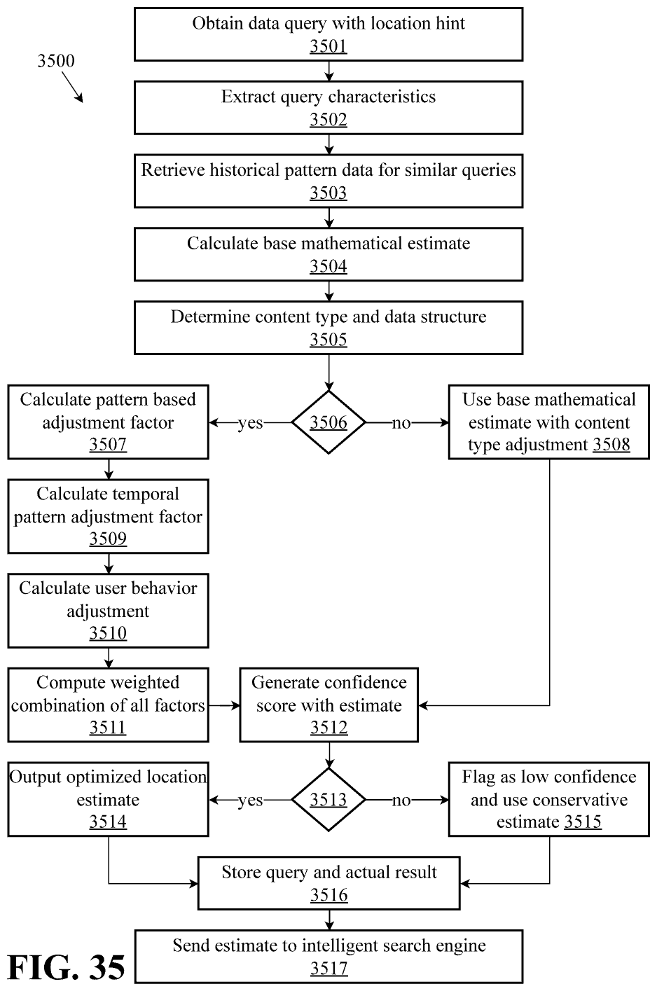

FIG. 35 is a flow diagram illustrating an exemplary method 3500 for adaptive location estimation that enhances the functionality of adaptive estimator module, according to an embodiment. The method improves upon the basic mathematical estimation approach of the original estimator module 2920 by incorporating learned patterns from historical queries, content type awareness, and user behavior analysis to provide more accurate starting locations for data searches within compacted files.

At step 3501, the method begins when adaptive estimator module 3402 receives, retrieves, or otherwise obtains a data query with a location hint from enhanced data query receiver 2910. The location hint may comprise various forms including, but not limited to, a specific byte position, a percentage location such as “start at 60% mark,” a relative position such as “near the beginning,” or contextual information such as “in the financial data section.” The method accommodates multiple location hint formats and extracts actionable positioning information regardless of the specific format used. In some implementations of an embodiment, the process may utilize sophisticated speech/text recognition and processing components to process a received query including, but not limited to, large language models (LLMs), transformers, and other natural language processing mechanisms.

At step 3502, query characteristics are extracted from the received data query to inform the estimation process. Query characteristic extraction analyzes the search term type, such as whether the query seeks a specific text string, binary pattern, structured data, or byte range. The extraction process identifies data type indicators that suggest whether the target data comprises text documents, database records, multimedia content, or executable code. Query characteristics may include, but are not limited to, temporal indicators such as date ranges, content categories such as customer records or regulatory documents, and structural hints such as file headers or data delimiters that help inform the estimation algorithm.

At step 3503, historical pattern data for similar queries is retrieved from learned access pattern store 3403 to inform the current estimation. The retrieval process searches for previous queries with similar characteristics including, but not limited to, matching search term types, comparable data content categories, equivalent file types, and analogous user contexts. Historical pattern data may comprise statistical information about where similar searches have succeeded in the past, typical offset patterns for specific data types, and temporal access trends that may affect data location within compacted files. The system maintains statistical models of successful location estimates organized by, for example, query type, content category, user profile, and temporal patterns.

At step 3504, a base mathematical estimate is calculated using the original estimation method to provide a foundation for optimization. The base calculation applies mathematical algorithms to convert the location hint from the original file coordinate system to an estimated bit position within the compacted file. This calculation considers the compression ratio, sourceblock size, and basic file structure information to generate an initial estimate similar to the approach used by estimator module 2920. The base estimate serves as a starting point that is subsequently refined using learned pattern data.

At step 3505, content type and data structure are determined through analysis of the compacted file metadata, query characteristics, and learned content patterns. Content type determination identifies whether the target file contains structured data such as database records, unstructured text such as documents, multimedia content such as images or video, or executable code such as software applications. Data structure analysis examines organization patterns such as chronological ordering, alphabetical sorting, hierarchical structures, or random organization that affect optimal search strategies. Content type information influences subsequent estimation adjustments by applying type-specific optimization factors.

At decision point 3506, the method determines whether sufficient historical data is available for the identified query characteristics and content type. Historical data availability assessment examines the quantity and quality of previous similar queries, the statistical significance of observed patterns, and the confidence level of existing pattern models. If the system has processed fewer than a minimum threshold of similar queries, or if the confidence level of existing patterns falls below a predetermined threshold, the method branches to step 3508 to use base mathematical estimation with content type adjustments. If sufficient historical data exists with adequate confidence levels, the method proceeds to step 3507 to apply learned pattern optimizations.

At step 3507, when historical data is available, a pattern-based adjustment factor is calculated using statistical analysis of previous query success data. Pattern-based adjustment factor calculation analyzes the difference between initial estimates and actual successful locations for similar historical queries. The calculation identifies systematic biases in the base mathematical estimation for specific content types and query characteristics. Statistical analysis may reveal that certain data types consistently require positive or negative offsets from mathematical estimates, or that specific search patterns correlate with particular location characteristics. The pattern-based adjustment factor quantifies these learned biases as a numerical correction that can be applied to the current estimate.

At step 3509, a temporal pattern adjustment factor is calculated to account for time-based access patterns and data organization changes. Temporal pattern analysis examines whether data access patterns vary by time of day, day of week, seasonal periods, or business cycles. The analysis identifies whether certain types of data are accessed more frequently during specific time periods, whether file organization changes over time affect location estimates, and whether user behavior patterns show temporal variations. Temporal adjustment factors account for scenarios such as financial data being accessed more frequently during quarter-end periods, or log files growing over time affecting the relative positions of historical data.

At step 3510, a user behavior adjustment factor is calculated based on individual user or user group access patterns. User behavior analysis examines whether specific users or user types demonstrate consistent search patterns, preferred data access sequences, or systematic location preferences. The analysis identifies user-specific biases such as preference for recent data, tendency to access related data sequentially, or focus on specific data categories. User behavior patterns may reveal that certain users consistently search for data in particular file regions, or that user roles such as analysts versus administrators demonstrate different access patterns that can inform location estimation.

At step 3511, a weighted combination of all factors is computed to generate the final optimized location estimate. The weighted combination algorithm assigns relative importance weights to the base mathematical estimate, pattern-based adjustment factor, temporal pattern adjustment factor, and user behavior adjustment factor based on the confidence level and statistical significance of each component. The combination process may use linear weighted averaging, non-linear combination functions, or machine learning algorithms such as neural networks to integrate multiple adjustment factors. The weighting scheme adapts based on the historical accuracy of different factors for similar query types and content categories.

At step 3508, when historical data is not available, the method uses the base mathematical estimate with content type adjustment. Content type adjustment applies predetermined optimization factors based on known characteristics of different data types without requiring historical learning data. Content type adjustments may include standard offset corrections for common file formats, typical organization patterns for structured versus unstructured data, and general search optimization strategies that do not depend on learned patterns. This approach ensures the system provides improved estimation even for novel query types that have not been encountered previously.

At step 3512, a confidence score is generated for the final location estimate based on the quality and quantity of data used in the estimation process. Confidence score calculation may consider factors including, but not limited to, the amount of historical data available, the statistical significance of observed patterns, the consistency of previous estimation accuracy, and the degree of similarity between the current query and historical examples. The confidence score provides a quantitative measure of estimation reliability that can be used by subsequent system components to make informed decisions about search strategies and resource allocation.

At decision point 3513, the method determines whether the confidence score exceeds a predetermined threshold to decide on the final estimation approach. The confidence threshold is configurable based on system requirements and performance targets, with higher thresholds resulting in more conservative estimation strategies and lower thresholds enabling more aggressive optimization attempts. If the confidence score exceeds the threshold, the method proceeds to step 3514 to use the optimized location estimate with full learned adjustments. If the confidence score falls below the threshold, the method proceeds to step 3515 to apply more conservative estimation strategies.

At step 3514, for high-confidence estimates, the optimized location estimate is output to intelligent search engine 3404 for use in subsequent search operations. The optimized estimate may comprise both the calculated bit position and associated metadata such as confidence score, adjustment factors applied, and recommended search strategies. High-confidence estimates enable intelligent search engine 3404 to apply aggressive optimization strategies and allocate resources efficiently based on the expected accuracy of the location estimate.

At step 3515, for low-confidence estimates, the system flags the estimate as low confidence and uses a conservative estimate that applies minimal adjustments to the base mathematical calculation. Conservative estimates may include wider search ranges, multiple starting positions, or fallback strategies that ensure successful data location even when estimation accuracy is uncertain. Low-confidence flagging enables subsequent system components to adapt their strategies appropriately and allocate additional resources for search operations that may require more extensive exploration.

At step 3516, query and actual result data are stored for future learning to continuously improve estimation accuracy. The storage process records the original query characteristics, location hint provided, estimation result generated, actual successful location found, and performance metrics achieved. This data feeds back into learned access pattern store 3403 to update statistical models and improve future estimation accuracy. The learning data includes both successful and unsuccessful estimation attempts to enable the system to learn from all experience and avoid repeating estimation errors.

At step 3517, the estimate is sent to intelligent search engine 3404 to initiate the search process using the optimized starting location. The estimate transmission may comprise the calculated bit position, confidence score, recommended search strategies, and any additional metadata that may assist search optimization. Intelligent search engine 3404 uses this information to select appropriate search algorithms, allocate computational resources, and implement fallback strategies based on the estimation quality and characteristics.

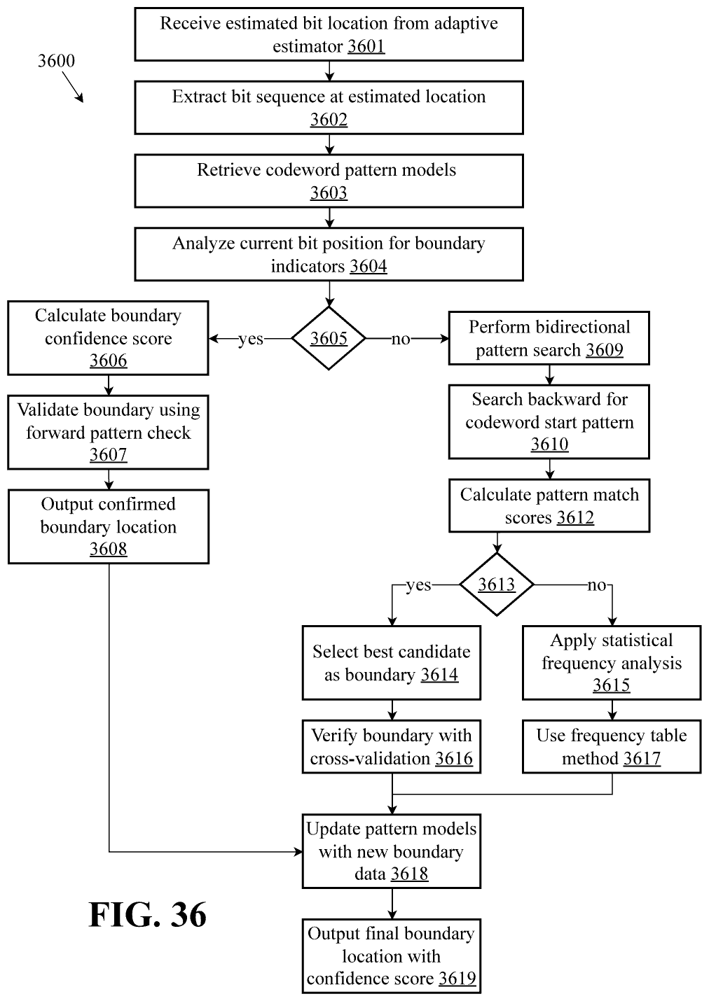

FIG. 36 is a flow diagram illustrating an exemplary method 3600 for predictive boundary detection that enhances the functionality of predictive boundary detector 3405 within intelligent search engine, according to an embodiment. The method improves upon the basic frequency table approach by incorporating learned codeword patterns and statistical models to more accurately identify codeword boundaries, thereby reducing the boundary misalignment problems where random access attempts result in incorrect output due to starting in the middle of a codeword.

At step 3601, the method begins when predictive boundary detector 3405 receives an estimated bit location from adaptive estimator module 3402. The estimated bit location may comprise the calculated starting position within the compacted data file along with associated metadata such as confidence score, content type information, and recommended search strategies. The estimated location may not align with an actual codeword boundary, requiring the boundary detection algorithm to find the nearest valid codeword start or end position to enable proper decoding of the compacted data.

At step 3602, a bit sequence is extracted at the estimated location to provide data for boundary analysis. The extraction process reads a predetermined window of bits centered around the estimated location, typically spanning multiple potential codewords to ensure adequate context for pattern matching. The bit sequence length can be dynamically adjusted based on one or more of the sourceblock size, content type, and confidence level of the initial estimate. For high-confidence estimates, smaller extraction windows may be sufficient, while low-confidence estimates require larger windows to accommodate greater uncertainty in the initial location.

At step 3603, codeword pattern models are retrieved from learned access pattern store 3403 to inform the boundary detection process. Codeword pattern models may comprise statistical information about common codeword structures, typical bit patterns that indicate codeword boundaries, frequency distributions of different codeword types, and learned associations between content types and codeword characteristics. The retrieval process selects pattern models that match the current file type, content category, and compression parameters to ensure relevant pattern matching criteria are applied.

At step 3604, the current bit position is analyzed for boundary indicators using the retrieved pattern models. Boundary indicator analysis examines bit patterns that statistically correlate with codeword boundaries, such as specific bit sequences that frequently appear at the start or end of codewords, padding patterns used in the compression algorithm, or structural markers embedded in the codeword format. The analysis applies pattern matching algorithms that compare the current bit sequence against learned boundary patterns and calculate similarity scores for potential boundary locations.

At decision point 3605, the method determines whether a strong boundary signal is detected based on the pattern analysis results. Strong boundary signal detection evaluates whether the pattern matching scores exceed predetermined confidence thresholds, whether multiple boundary indicators align at the same location, and whether the detected patterns are consistent with the expected codeword structure for the current content type. If clear boundary indicators are found with high confidence scores, the method proceeds to validate and confirm the boundary location. If boundary signals are weak or ambiguous, the method initiates a more comprehensive search process.

At step 3606, when a strong boundary signal is detected, a boundary confidence score is calculated based on the strength and consistency of the detected patterns. Boundary confidence score calculation considers factors including the magnitude of pattern matching scores, the number of different boundary indicators that align at the location, the consistency with expected codeword structure, and the historical accuracy of similar pattern matches. The confidence score provides a quantitative measure of boundary detection reliability that influences subsequent processing decisions and search strategies.

At step 3607, the detected boundary is validated using forward pattern checking to confirm that the identified location represents a genuine codeword boundary. Forward pattern validation examines the bit patterns that follow the detected boundary to verify they are consistent with expected codeword content and structure. The validation process checks whether subsequent bits form valid codewords according to the reference codebook, whether the detected boundary enables successful decoding of following data, and whether the overall bit sequence structure is consistent with the compression format.

At step 3608, when validation confirms the boundary location, the confirmed boundary location is output to intelligent search engine 3404 for use in subsequent search operations. The output may comprise, but is not limited to, the precise bit position of the confirmed boundary, the confidence score associated with the detection, metadata about the pattern matching results, and recommendations for optimal search strategies based on the detected codeword structure.

At step 3609, when strong boundary signals are not initially detected, the method performs bidirectional pattern search to locate the nearest valid codeword boundaries. Bidirectional pattern search examines bit sequences both before and after the estimated location to identify patterns that indicate codeword start and end positions. The search process can apply sliding window analysis that systematically examines different bit positions to find locations where boundary patterns occur with sufficient confidence.

At step 3610, the backward search component searches for codeword start patterns by examining bit sequences preceding the estimated location. Backward search analysis applies learned pattern models to identify bit patterns that typically indicate the beginning of codewords, structural markers that denote codeword boundaries, or padding sequences that separate adjacent codewords. The search process maintains multiple candidate locations with associated confidence scores to enable comparison and selection of the most likely boundary position.

At step 3611, the forward search component searches for codeword end patterns by examining bit sequences following the estimated location. Forward search analysis identifies patterns that indicate codeword termination, structural markers that denote the end of data blocks, or padding sequences that prepare for subsequent codewords. The forward search coordinates with the backward search to identify complete codeword boundaries that properly frame valid data blocks.

At step 3612, pattern match scores are calculated for all candidate boundary locations identified by the bidirectional search process. Pattern match score calculation applies statistical analysis to compare detected patterns against learned models, evaluates the consistency of boundary indicators across multiple candidate locations, and considers the overall structural coherence of the identified codeword boundaries. The scoring process generates quantitative measures that enable objective comparison of different candidate boundary locations.

At decision point 3613, the method determines whether the best candidate score exceeds a minimum threshold required for reliable boundary detection. The minimum threshold can be configured based on system requirements, content type characteristics, and acceptable error rates for boundary detection. If the highest-scoring candidate location meets the minimum confidence requirements, the method proceeds to select and validate that boundary. If no candidates achieve sufficient confidence scores, the method falls back to traditional frequency analysis methods.

At step 3614, when suitable candidates are identified, the best candidate is selected as the boundary location based on the highest pattern match score and overall confidence assessment. Best candidate selection considers not only the individual pattern match scores but also the consistency with surrounding data structure, the compatibility with expected codeword formats, and the likelihood of successful subsequent decoding operations. The selection process may apply additional weighting factors based on content type and historical performance data.

At step 3616, the selected boundary undergoes cross-validation to confirm its accuracy and reliability. Cross-validation can comprise testing the boundary location by attempting to decode data from that position, verifying that the decoded results are consistent with expected content types and structures, and checking that adjacent boundaries can be successfully identified using the same methodology. Cross-validation provides additional confidence in the boundary selection and helps identify cases where the detection algorithm may have produced false positive results.

At step 3615, when pattern matching fails to identify suitable candidates, the method applies statistical frequency analysis as a fallback approach. Statistical frequency analysis fallback uses traditional methods similar to those described herein, examining bit patterns for statistical anomalies that may indicate codeword boundaries, applying frequency distribution analysis to identify unusual bit sequences, and using entropy analysis to detect structural changes in the data stream.

At step 3617, the frequency table method from the original system is used when pattern-based approaches fail to identify reliable boundaries. Frequency table method application examines the bit sequences using the frequency table 2950 approach described in the original random access system, applies statistical analysis to identify improbable bit sequences that suggest boundary misalignment, and uses iterative refinement to locate positions where decoded results are more consistent with expected data patterns.

At step 3618, pattern models are updated with new boundary data to improve future detection accuracy through continuous learning. Pattern model updates incorporate information about successful boundary detections, failed detection attempts, and the accuracy of different pattern matching approaches for various content types. The update process refines statistical models, adjusts pattern matching thresholds, and incorporates new boundary patterns discovered during the detection process to enhance future performance.

At step 3619, the final boundary location is output along with an associated confidence score to enable intelligent search engine 3404 to make informed decisions about subsequent search strategies. The output may comprise, but is not limited to, the precise bit position of the detected boundary, a confidence score reflecting the reliability of the detection, metadata about the detection method used, and recommendations for search optimization based on the boundary characteristics and detection quality. This information enables intelligent search engine 3404 to adapt its search strategies appropriately and allocate resources efficiently based on the expected accuracy of the boundary detection results.

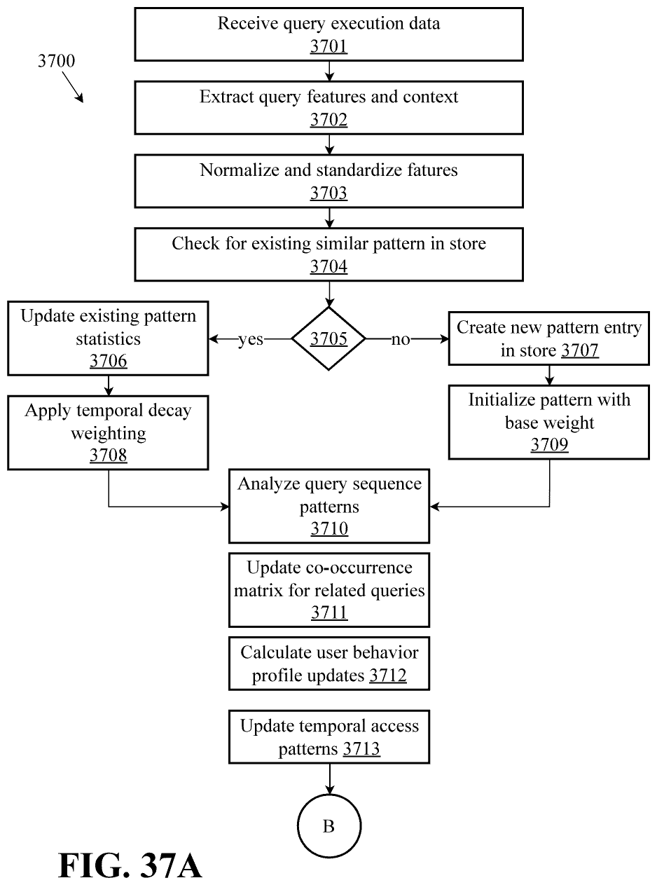

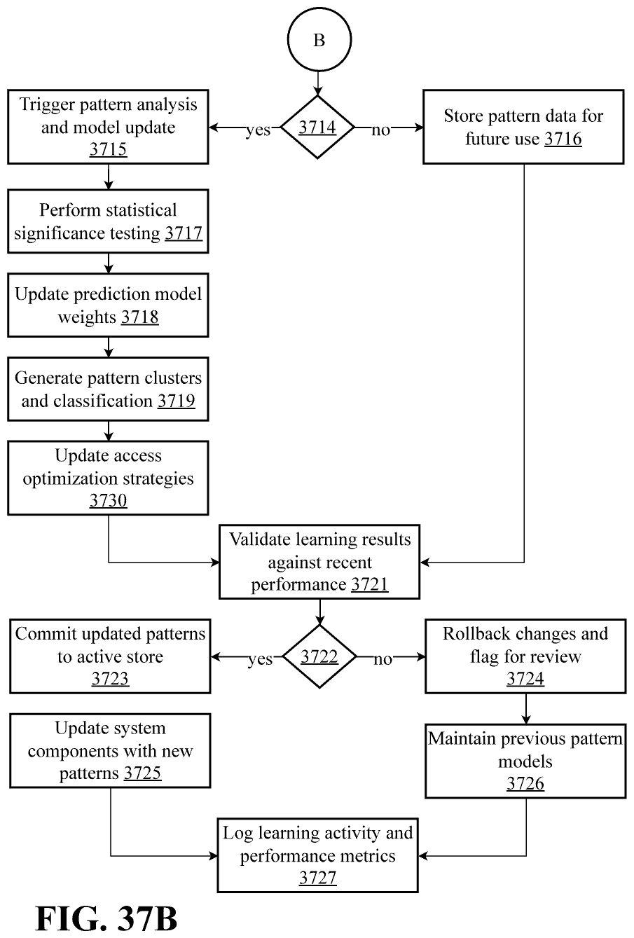

FIGS. 37A and 37B present a flow diagram illustrating an exemplary method 3700 for query pattern learning that enables query pattern learning module 3401 to continuously analyze and learn from query execution data to improve system performance, according to an embodiment. The method can implement online learning algorithms that build statistical models of user behavior, access patterns, and query relationships to inform optimization decisions throughout adaptive random access system 3400. The learning process operates continuously during system operation, analyzing each query execution to refine understanding of data access patterns and user behavior.

At step 3701, the method begins when query pattern learning module 3401 receives query execution data from various system components including enhanced data query receiver 2910, intelligent search engine 3404, and other system modules. Query execution data includes the original query parameters such as search terms and location hints, timing information including query submission time and completion time, performance metrics such as search duration and boundary detection accuracy, user context information such as user identity and role, and result quality metrics such as whether the query was successful and required refinement. The data collection process operates continuously to capture comprehensive information about all query activities within the system.

At step 3702, query features and context are extracted from the received execution data to create standardized representations suitable for pattern analysis. Query feature extraction identifies key characteristics including query type such as string search or byte range request, content type indicators such as document format and data category, temporal context such as time of day and date, user characteristics such as role and department, file characteristics such as size and compression ratio, and performance indicators such as success rate and response time. Context extraction captures environmental factors that may influence query patterns including system load, available resources, concurrent user activity, and historical access trends.

At step 3703, features are normalized and standardized to ensure consistent representation across different query types and contexts. Normalization process converts various feature formats into standardized numerical representations, applies scaling transformations to ensure features have comparable ranges, handles missing or incomplete data through imputation or default values, and creates feature vectors that can be processed by machine learning algorithms. Standardization ensures that patterns learned from different query types and user contexts can be effectively compared and combined to generate comprehensive access models.

At step 3704, the system checks for existing similar patterns in learned access pattern store 3403 to determine whether the current query represents a novel pattern or an instance of a previously observed behavior. Similar pattern detection applies similarity metrics such as cosine similarity or Euclidean distance to compare the current query features against stored pattern templates, uses clustering algorithms to identify queries that belong to existing pattern groups, and applies threshold-based matching to determine whether sufficient similarity exists to update an existing pattern rather than creating a new one. The detection process considers both exact feature matches and approximate similarities that indicate related access behaviors.

At decision point 3705, the method determines whether a sufficiently similar pattern was found in the existing pattern store. Similar pattern determination evaluates whether the similarity scores exceed predetermined thresholds, whether the contextual factors are compatible with existing patterns, and whether the current query represents a variation of a known pattern or a genuinely novel access behavior. If similar patterns are found, the method proceeds to update existing statistical models. If no similar patterns exist, the method creates new pattern entries to capture the novel access behavior.

At step 3706, when similar patterns are found, existing pattern statistics are updated to incorporate the new query data. Pattern statistics updates include incrementing frequency counters for the observed pattern, updating timing information such as average response time and typical access duration, refining context associations such as user types and content categories, and adjusting success rate statistics based on the current query outcome. The update process applies incremental learning algorithms that modify existing statistical models without requiring complete recomputation of all historical data.

At step 3708, temporal decay weighting is applied to existing patterns to ensure that recent observations have greater influence on the learned models than historical data. Temporal decay weighting reduces the influence of older observations according to configurable decay functions, increases the weight of recent patterns to reflect changing user behavior and system characteristics, and balances historical knowledge with adaptation to evolving access patterns. The decay process ensures that learned models remain current and responsive to changing conditions while preserving valuable long-term trends.

At step 3707, when no similar patterns are found, a new pattern entry is created in learned access pattern store 3403 to capture the novel access behavior. New pattern creation establishes initial statistical models based on the current query data, assigns unique identifiers for pattern tracking and reference, initializes frequency counters and timing statistics, and establishes relationships with related patterns and content categories. The creation process ensures that novel patterns are properly integrated into the existing pattern framework and can contribute to future optimization decisions.

At step 3709, new patterns are initialized with base weights that reflect their initial statistical significance and reliability. Base weight initialization assigns initial confidence scores based on the quality and completeness of the query data, establishes starting parameters for statistical models, and sets threshold values for pattern significance testing. Base weights ensure that new patterns are appropriately weighted in optimization decisions while they accumulate sufficient data to demonstrate statistical significance.

At step 3710, query sequence patterns are analyzed to identify relationships and dependencies between consecutive queries. Sequence pattern analysis examines temporal relationships between queries to identify common access workflows, analyzes user behavior patterns that involve multiple related queries, identifies data access sequences that suggest content relationships, and detects cyclical patterns that indicate recurring workflows or scheduled activities. Sequence analysis enables the system to predict future queries based on current access patterns and optimize resource allocation accordingly.

At step 3711, co-occurrence matrices are updated for related queries to capture statistical relationships between different types of data access. Co-occurrence matrix updates track which queries tend to occur together within specific time windows, measure the strength of relationships between different query types and content categories, identify user behavior patterns that involve predictable query sequences, and maintain statistical models of query dependencies that inform prefetching and optimization strategies. Co-occurrence data enables the system to anticipate related queries and prepare resources proactively.

At step 3712, user behavior profile updates are calculated to refine understanding of individual and group access patterns. User behavior profile updates analyze individual user access patterns to identify personal preferences and workflow characteristics, examine role-based patterns that reflect organizational structure and responsibilities, track changes in user behavior over time to detect evolving needs and responsibilities, and maintain statistical models of user groups that enable collaborative optimization strategies. User profiles enable personalized optimization strategies that improve individual user experience while contributing to overall system efficiency.

At step 3713, temporal access patterns are updated to capture time-based variations in query behavior and system usage. Temporal pattern updates analyze daily, weekly, and seasonal cycles in data access patterns, track correlations between specific time periods and query types, identify peak usage periods and resource requirements, and maintain statistical models of temporal trends that inform capacity planning and optimization strategies. Temporal patterns enable the system to anticipate demand changes and allocate resources efficiently across different time periods.

Referring now to FIG. 37B, at decision point 3714, the method determines whether pattern count exceeds the learning threshold required to trigger comprehensive pattern analysis and model updates. Learning threshold evaluation examines whether sufficient data has been collected to perform statistically significant analysis, determines whether pattern changes are substantial enough to warrant model updates, and considers system resource availability for performing intensive learning computations. If the threshold is exceeded, the method proceeds to comprehensive pattern analysis. If insufficient data exists, pattern data is stored for future analysis when more observations become available.

At step 3715, when the learning threshold is exceeded, pattern analysis and model updates are triggered to refine the overall learning framework. Pattern analysis involves comprehensive statistical analysis of accumulated pattern data, identification of significant trends and relationships in access behavior, detection of changes in user behavior or system characteristics, and optimization of prediction algorithms based on observed performance. Model updates incorporate new learning results into the active optimization systems used throughout adaptive random access system 3400.

At step 3717, statistical significance testing is performed to validate the reliability and importance of observed patterns. Statistical significance testing applies hypothesis testing to determine whether observed patterns represent genuine trends or random variation, calculates confidence intervals for pattern statistics to assess reliability, identifies patterns that achieve statistical significance for inclusion in optimization algorithms, and filters out patterns that may represent noise or insufficient data. Significance testing ensures that only reliable patterns contribute to system optimization decisions.

At step 3718, prediction model weights are updated based on the statistical analysis results to improve future optimization accuracy. Prediction model weight updates adjust the relative importance of different pattern types and features in optimization algorithms, incorporate performance feedback to refine prediction accuracy, balance individual patterns with overall system performance, and ensure that model updates improve rather than degrade system performance. Weight updates enable continuous improvement of prediction accuracy through iterative refinement.

At step 3719, pattern clusters and classifications are generated to organize learned patterns into coherent groups that facilitate efficient optimization decisions. Pattern clustering applies machine learning algorithms such as k-means or hierarchical clustering to group similar access patterns, creates taxonomies of query types and user behaviors, identifies representative patterns that characterize different usage scenarios, and establishes pattern hierarchies that enable efficient pattern matching and optimization. Clustering enables efficient organization and retrieval of learned patterns for optimization purposes.

At step 3720, access optimization strategies are updated based on the refined pattern understanding to improve system performance. Optimization strategy updates modify algorithms used by adaptive estimator module 3402, predictive boundary detector 3405, and other system components, refine prefetching and caching strategies based on learned access patterns, adjust resource allocation policies to reflect observed usage patterns, and update search strategies to leverage identified query relationships. Strategy updates ensure that learning results translate into improved system performance.

At step 3716, when the learning threshold is not exceeded, pattern data is stored for future analysis when sufficient observations become available. Pattern data storage maintains accumulated observations in a format suitable for future analysis, preserves temporal information and context for delayed processing, ensures data integrity and availability for subsequent learning cycles, and optimizes storage efficiency for large volumes of pattern data. Stored pattern data contributes to future learning cycles when sufficient volume is available for statistical analysis.

At step 3721, learning results are validated against recent system performance to ensure that pattern updates improve rather than degrade system operation. Learning validation compares system performance before and after pattern updates, analyzes whether optimization strategies based on new patterns achieve expected improvements, identifies cases where learning results may be unreliable or counterproductive, and provides feedback for refining learning algorithms and processes. Validation ensures that learning activities contribute positively to system performance.

At decision point 3722, the method determines whether validation was successful based on performance improvement metrics and statistical significance tests. Validation success evaluation examines whether system performance metrics improved following pattern updates, determines whether improvements are statistically significant and not due to random variation, assesses whether learning results are consistent with expected outcomes, and identifies potential negative impacts that may require corrective action. Successful validation enables commitment of updated patterns to active system operation.

At step 3723, when validation is successful, updated patterns are committed to learned access pattern store 3403 for use by active system components. Pattern commitment involves updating the active pattern database with refined statistical models, enabling system components to access improved optimization data, implementing new optimization strategies based on learning results, and establishing monitoring to track ongoing performance improvements. Committed patterns become part of the active optimization framework used throughout the system.

At step 3725, system components are updated with new patterns to ensure that learning results are applied consistently across adaptive random access system 3400. System component updates notify adaptive estimator module 3402, predictive boundary detector 3405, and other components of available pattern improvements, provide updated optimization parameters and strategies, ensure consistent application of learning results across all system functions, and coordinate pattern deployment to avoid conflicts or inconsistencies. Component updates ensure that learning benefits are realized throughout the system.

At step 3724, when validation fails, changes are rolled back and flagged for review to prevent degradation of system performance. Change rollback restores previous pattern models and optimization strategies, identifies potential causes of validation failure for further investigation, flags problematic learning results for manual review and analysis, and implements safeguards to prevent similar validation failures. Rollback procedures ensure system stability and reliability while enabling investigation of learning algorithm issues.

At step 3726, when changes are rolled back, previous pattern models are maintained to preserve system functionality while learning issues are resolved. Pattern model maintenance preserves existing optimization capabilities, continues system operation using previously validated patterns, maintains performance monitoring to detect any ongoing issues, and enables future learning attempts when algorithm improvements are available. Model maintenance ensures continuous system operation despite temporary learning difficulties.

At step 3727, learning activity and performance metrics are logged to provide comprehensive records of pattern learning operations and outcomes. Activity logging records details of learning processes including pattern updates and validation results, tracks performance metrics before and after learning activities, maintains audit trails for pattern changes and system modifications, and provides data for future analysis and improvement of learning algorithms. Comprehensive logging enables continuous improvement of the learning framework and troubleshooting of learning-related issues.

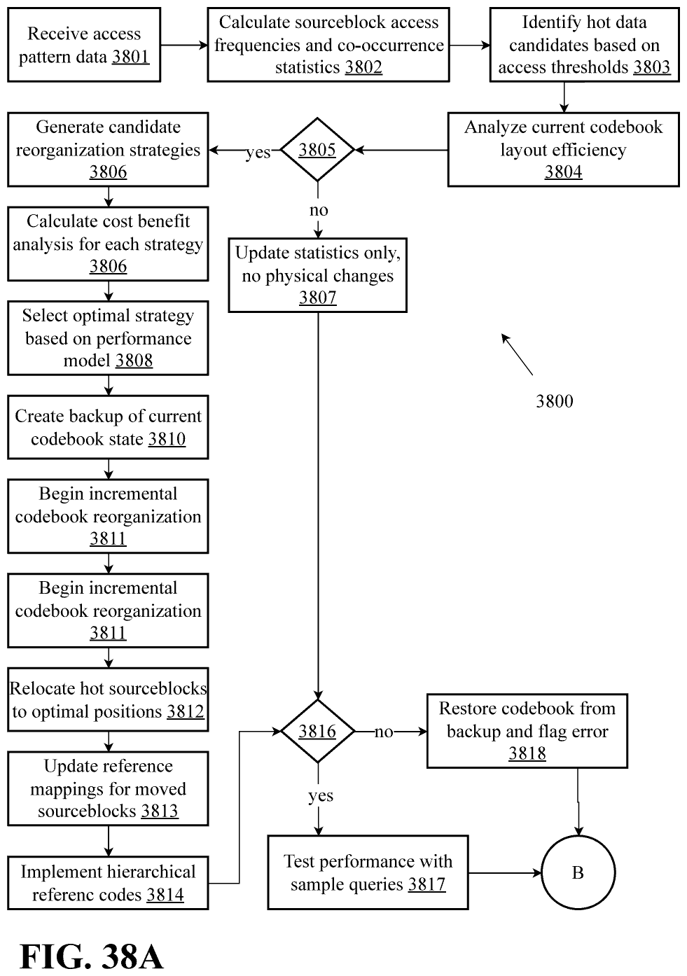

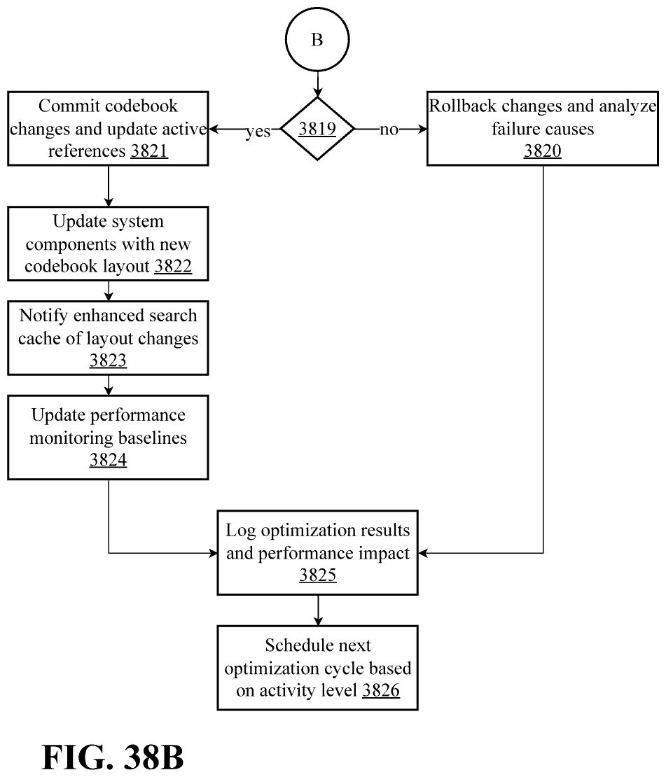

FIGS. 38A and 38B present a flow diagram illustrating an exemplary method 3800 for dynamic codebook optimization that enables dynamic codebook optimizer 3411 within adaptive codebook manager to reorganize the reference codebook structure based on learned access patterns to improve system performance, according to an embodiment. The method implements intelligent reorganization strategies that move frequently accessed sourceblocks to optimal positions within the codebook, implement hierarchical reference coding schemes, and maintain backward compatibility while enhancing access efficiency. The optimization process operates periodically based on accumulated access pattern data and system performance metrics.

At step 3801, the method begins when dynamic codebook optimizer 3411 receives access pattern analysis data from access pattern analyzer 3410 within adaptive codebook manager 3409. Access pattern analysis data may comprise statistical information about sourceblock access frequencies, temporal patterns indicating when different sourceblocks are accessed, co-occurrence data showing which sourceblocks are frequently accessed together, user behavior patterns indicating access preferences and workflows, and performance metrics measuring current codebook efficiency and access latency. The data represents accumulated observations over a configurable time period that provides sufficient statistical significance for optimization decisions.

At step 3802, sourceblock access frequencies and co-occurrence statistics are calculated from the received pattern analysis data. Access frequency calculation determines how often each sourceblock has been accessed during the analysis period, identifies sourceblocks that exceed frequency thresholds for hot data classification, calculates relative access rates to enable comparative analysis, and applies temporal weighting to emphasize recent access patterns. Co-occurrence statistics analysis identifies pairs and groups of sourceblocks that are frequently accessed together, measures the strength of relationships between different sourceblocks, calculates correlation coefficients for sourceblock access patterns, and identifies access sequences that suggest workflow dependencies.

At step 3803, hot data candidates are identified based on access thresholds and statistical significance criteria. Hot data identification applies configurable frequency thresholds to classify sourceblocks as hot, warm, or cold based on access patterns, considers both absolute access counts and relative access rates compared to average system usage, analyzes temporal consistency to ensure that high access rates represent sustained patterns rather than temporary spikes, and evaluates co-occurrence patterns to identify sourceblocks that should be grouped together for optimal access. Hot data candidates represent sourceblocks that would benefit most from optimization strategies such as repositioning or hierarchical reference coding.

At step 3804, current codebook layout efficiency is analyzed to establish baseline performance metrics and identify optimization opportunities. Codebook layout analysis examines the physical organization of sourceblocks within the codebook structure, measures access latency for different sourceblock positions, calculates the efficiency of current reference code assignments, and identifies bottlenecks or inefficiencies in the existing layout. Efficiency analysis considers factors such as the relationship between sourceblock position and access speed, the effectiveness of current hierarchical coding schemes, and the alignment between access patterns and codebook organization.

At decision point 3805, the method determines whether optimization potential exceeds the benefit threshold required to justify reorganization activities. Benefit threshold evaluation calculates the expected performance improvement from proposed optimizations, compares projected benefits against the computational and resource costs of reorganization, considers the potential disruption to system operation during optimization, and evaluates the statistical significance of observed access patterns. If the potential benefits exceed the threshold, the method proceeds with optimization planning. If benefits are insufficient, the method updates statistics without making physical changes to the codebook.

At step 3806, when optimization is justified, candidate reorganization strategies are generated based on the access pattern analysis and performance modeling. Strategy generation creates multiple alternative approaches for codebook reorganization including sourceblock repositioning strategies that move hot data to optimal locations, hierarchical coding schemes that assign shorter reference codes to frequently accessed sourceblocks, clustering strategies that group related sourceblocks together, and hybrid approaches that combine multiple optimization techniques. Each candidate strategy is designed to address specific performance bottlenecks identified in the current codebook layout.

At step 3808, cost-benefit analysis is calculated for each candidate reorganization strategy to enable objective comparison and selection. Cost-benefit analysis estimates the performance improvement expected from each strategy, calculates the computational resources required for implementation, measures the potential disruption to ongoing system operation, and evaluates the long-term sustainability of each approach. The analysis considers factors such as the stability of access patterns, the scalability of proposed changes, and the compatibility with future optimization opportunities.

At step 3809, the optimal strategy is selected based on performance modeling and cost-benefit analysis results. Strategy selection applies multi-criteria decision making that weights different factors such as performance improvement potential, implementation cost, and risk assessment. Selection process considers both immediate performance benefits and long-term optimization sustainability, evaluates the compatibility of proposed changes with system architecture and constraints, and chooses the strategy that provides the best overall value for system performance improvement.

At step 3810, a backup of the current codebook state is created to enable rollback in case optimization results are unsatisfactory. Codebook backup creation preserves the complete current codebook structure including sourceblock positions and reference code mappings, stores metadata about the current performance baseline and configuration parameters, creates checkpoint information that enables precise restoration of the previous state, and implements backup validation to ensure data integrity and completeness. Backup creation provides essential safety mechanisms for the optimization process.

At step 3811, incremental codebook reorganization begins using the selected optimization strategy. Incremental reorganization implements changes gradually to minimize system disruption, maintains system availability during the optimization process, applies changes in phases that can be validated and rolled back independently, and monitors system performance continuously during reorganization. Incremental approach ensures that optimization benefits can be realized progressively while maintaining system stability and reliability.

At step 3812, hot sourceblocks are relocated to optimal positions within the codebook structure based on the selected optimization strategy. Sourceblock relocation moves frequently accessed sourceblocks to positions that minimize access latency, implements physical reorganization of codebook storage to optimize data locality, updates internal data structures to reflect new sourceblock positions, and maintains referential integrity during the relocation process. Relocation process prioritizes the most frequently accessed sourceblocks to maximize performance improvement while minimizing reorganization overhead.

At step 3813, reference code mappings are updated for moved sourceblocks to maintain consistency between sourceblocks and their reference codes. Reference code mapping updates modify lookup tables to reflect new sourceblock positions, update hash tables and indexing structures used for sourceblock retrieval, implement atomic updates to prevent inconsistent states during the update process, and validate mapping accuracy to ensure correct sourceblock retrieval. Mapping updates preserve the logical relationship between reference codes and sourceblocks while accommodating physical reorganization.

At step 3814, hierarchical reference codes are implemented to assign shorter, more

efficient codes to frequently accessed sourceblocks. Hierarchical reference code implementation applies adaptive Huffman coding principles based on actual access frequencies, creates multi-level coding schemes that prioritize hot data with shorter codes, implements variable-length encoding that optimizes for access patterns rather than uniform distribution, and maintains compatibility with existing reference code structures. Hierarchical coding reduces the average reference code length for frequently accessed data, improving both storage efficiency and access speed.

At step 3815, codebook integrity and reference accuracy are validated to ensure that reorganization has not introduced errors or inconsistencies. Codebook validation performs comprehensive consistency checks between reference codes and sourceblocks, validates that all sourceblocks remain accessible through their reference codes, checks that codebook structure conforms to system requirements and constraints, and verifies that reorganization has not corrupted data or introduced invalid references. Validation provides critical quality assurance for the optimization process.

At decision point 3816, the method determines whether validation was successful based on integrity checks and accuracy verification. Validation success evaluation examines whether all consistency checks passed without errors, determines whether reference code mappings are functioning correctly, assesses whether reorganization has maintained data integrity, and identifies any issues that require corrective action. Successful validation enables performance testing and potential commitment of changes. Failed validation triggers rollback procedures to restore the previous codebook state.

At step 3817, when validation succeeds, performance is tested with sample queries to measure the effectiveness of optimization changes. Performance testing executes representative queries against the reorganized codebook, measures access latency and system responsiveness, compares performance metrics against baseline measurements, and evaluates whether optimization has achieved expected improvements. Testing uses realistic query patterns that reflect actual system usage to provide accurate performance assessment.

Referring now to FIG. 38B, at decision point 3819, the method determines whether performance has improved based on testing results and statistical analysis. Performance improvement evaluation compares post-optimization metrics against baseline performance, applies statistical significance testing to ensure improvements are genuine rather than random variation, considers multiple performance dimensions such as latency, throughput, and resource utilization, and evaluates whether improvements meet or exceed expectations. Performance improvement validation ensures that optimization changes provide measurable benefits to system operation.

At step 3821, when performance improvement is confirmed, codebook changes are committed and active references are updated throughout the system. Change commitment makes optimization modifications permanent in the active codebook, updates all system components to use the new codebook organization, implements new reference code mappings in production operation, and removes backup data that is no longer needed. Commitment process ensures that optimization benefits are fully realized in system operation.

At step 3822, system components are updated with the new codebook layout to ensure consistent operation across adaptive random access system 3400. System component updates notify intelligent search engine 3404, predictive boundary detector 3405, and other components of codebook changes, provide updated reference code mappings and access strategies, ensure coordinated adoption of optimization improvements, and validate that all components are functioning correctly with the new codebook layout. Component updates ensure system-wide consistency and optimal performance.

At step 3823, enhanced search cache 3419 is notified of layout changes to enable cache optimization based on the new codebook organization. Cache notification provides information about sourceblock relocations and new access patterns, enables cache strategies to adapt to optimized codebook layout, updates cache replacement policies to reflect new hot data locations, and ensures that caching strategies remain aligned with codebook optimization. Cache coordination maximizes the combined benefits of codebook optimization and intelligent caching.

At step 3824, performance monitoring baselines are updated to reflect the new optimized performance levels. Baseline updates establish new performance expectations based on optimization results, reset monitoring thresholds to detect future performance degradation, update performance trending analysis to account for optimization improvements, and provide reference points for future optimization activities. Updated baselines enable continuous performance monitoring and future optimization planning.

At step 3818, when validation fails, the codebook is restored from backup and errors are flagged for analysis. Codebook restoration returns the system to the previous known-good state, implements rollback procedures that reverse all optimization changes, preserves error information for debugging and analysis, and ensures system stability and reliability. Restoration procedures provide essential safety mechanisms that prevent optimization failures from affecting system operation.

At step 3820, when performance testing shows no improvement or degradation, changes are rolled back and failure causes are analyzed. Change rollback restores the previous codebook state using backup data, analyzes why optimization failed to achieve expected benefits, identifies potential issues with optimization algorithms or assumptions, and preserves failure information for algorithm improvement. Rollback procedures ensure that unsuccessful optimization attempts do not degrade system performance.

At step 3807, when optimization potential does not exceed the benefit threshold, statistics are updated without making physical changes to the codebook. Statistics-only updates preserve access pattern information for future optimization cycles, update monitoring data and trend analysis, maintain readiness for future optimization when conditions become favorable, and continue performance monitoring without system disruption. Statistics updates ensure continuous learning and preparation for future optimization opportunities.

At step 3825, optimization results and performance impact are logged to provide comprehensive records of optimization activities and outcomes. Result logging records details of optimization strategies implemented, measures performance improvements or issues encountered, maintains audit trails for codebook changes and system modifications, and provides data for future optimization algorithm improvement. Comprehensive logging enables continuous improvement of optimization processes and troubleshooting of optimization-related issues.

At step 3826, the next optimization cycle is scheduled based on system activity level and performance monitoring results. Optimization scheduling determines appropriate intervals for future optimization based on the rate of access pattern changes, schedules optimization during low-activity periods to minimize system impact, adapts scheduling frequency based on system usage patterns and performance requirements, and ensures regular optimization opportunities while maintaining system stability. Scheduling coordination ensures ongoing optimization benefits while minimizing operational disruption.

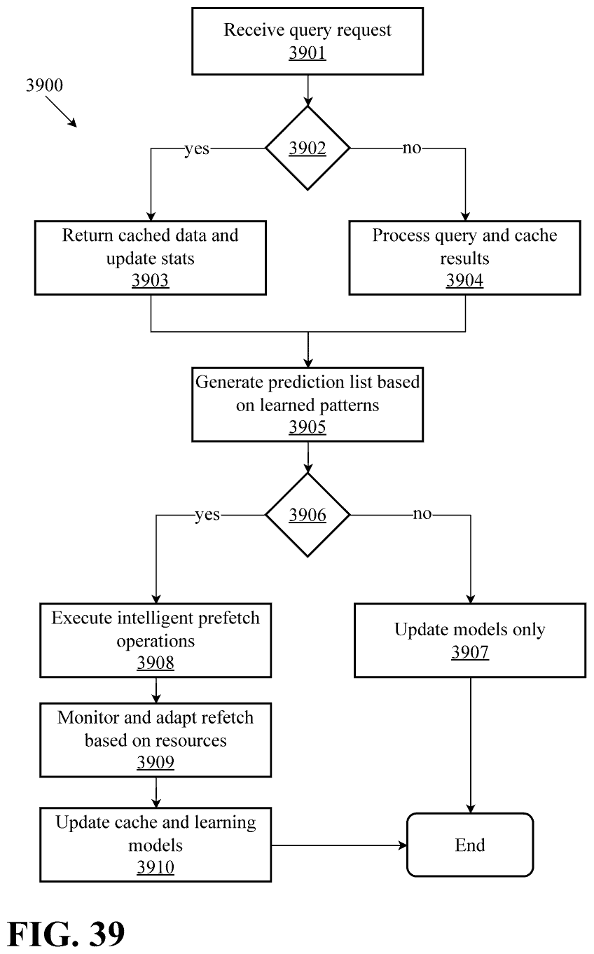

FIG. 39 is a flow diagram illustrating an exemplary method 3900 for enhanced search cache management that enables enhanced search cache to implement predictive caching algorithms that anticipate user queries and proactively load relevant data to improve system response times, according to an embodiment. The method builds upon the basic search cache functionality described herein by incorporating learned access patterns, user behavior analysis, and intelligent resource management to provide significant performance improvements through predictive data loading and optimized cache replacement policies.

At step 3901, the method begins when enhanced search cache 3419 receives a query request from intelligent search engine 3404. Query request information may comprise the search parameters such as search terms and target file identification, timing information including submission time and user session context, user identification and role information for personalized optimization, and system context such as current load and available resources. Context information enables the cache management system to make informed decisions about caching strategies and resource allocation based on comprehensive understanding of the query environment. Enhanced search cache 3419 extracts and normalizes query features to create standardized representations suitable for cache lookup and pattern analysis.

At step 3902, the method determines whether a cache hit was found by checking the current cache for requested data. Cache checking process searches cache indexes and metadata to locate matching data, evaluates cache entry validity and freshness based on configurable expiration policies, assesses cache entry completeness to ensure full query satisfaction, and measures cache hit accuracy for performance tracking. Cache checking implements efficient lookup mechanisms that minimize latency while providing comprehensive search capabilities across cached data. Cache hit evaluation examines whether matching data exists in the cache with sufficient quality and completeness, determines whether cached data meets freshness requirements and validity constraints, assesses whether partial matches can contribute to query satisfaction, and evaluates the confidence level of cached data for the current query context.

At step 3903, when a cache hit is found, cached data is returned and statistics are updated to maintain performance metrics and support learning algorithms. Cache statistics updates include incrementing hit counters for performance monitoring, updating access frequency data for cached items, recording timing information for latency analysis, and maintaining cache effectiveness metrics. Data return process provides the cached results to intelligent search engine 3404 with appropriate metadata including cache age, confidence level, and source information to enable informed use of cached data. The method also analyzes user query context for prediction purposes even when immediate data needs are satisfied. Query context analysis examines the current query in relation to user behavior patterns, identifies potential follow-up queries based on historical access sequences, analyzes session context to understand ongoing user workflows, and evaluates temporal patterns that may indicate future data needs.

At step 3904, when no cache hit is found, the method processes the query and caches results while implementing comprehensive data retrieval and storage strategies. Query processing coordinates with intelligent search engine 3404 to execute the search operation, monitors query performance and timing characteristics, prepares retrieved data for caching with appropriate metadata, and analyzes query results for quality and completeness. Data caching process stores query results with timestamp and validity information, associates cached data with user context and query characteristics, implements appropriate indexing for efficient future retrieval, and applies compression or optimization techniques to maximize cache efficiency. Metadata storage includes information about data source, retrieval method, confidence level, and relationships to other cached data. Query pattern analysis identifies features of the current query that correlate with historical access patterns, examines query timing and context for temporal prediction opportunities, analyzes query content and structure for semantic relationships with potential future queries, and applies machine learning algorithms to generate prediction probabilities.

At step 3905, a prediction list of likely next queries is generated based on learned access patterns and comprehensive analysis of user behavior. Learned access patterns are retrieved for the current user or user group, obtaining historical data about user query sequences and preferences, accessing statistical models of user behavior and workflow patterns, retrieving temporal access patterns that indicate time-based query trends, and obtaining collaborative filtering data that suggests patterns based on similar users. Prediction generation applies statistical models and machine learning algorithms to identify potential future queries, estimates probability distributions for different query types and timing, considers user workflow patterns and typical access sequences, and generates ranked lists of predicted queries with associated confidence scores. Prediction confidence scores are calculated for each predicted query considering the statistical significance of supporting pattern data, evaluating the similarity between current context and historical successful predictions, assessing the stability and consistency of underlying access patterns, and applying temporal weighting to emphasize recent behavioral trends. Confidence scores enable intelligent selection of predictions most likely to benefit system performance.

At step 3906, the method determines whether sufficient resources are available for prefetching by assessing current cache capacity and available system resources. Resource assessment examines available memory for cache expansion, evaluates network bandwidth available for data retrieval, assesses storage capacity for cached data, and considers computational resources required for prefetching operations. Resource sufficiency evaluation compares required resources for prefetching against available system capacity, considers the impact of prefetching on ongoing system operations, evaluates trade-offs between prefetching benefits and resource costs, and applies configurable policies for resource allocation and prioritization. Resource decision-making ensures that prefetching enhances rather than degrades overall system performance.

At step 3908, when sufficient resources are available, intelligent prefetch operations are executed using sophisticated prioritization and resource management strategies. Predictions are prioritized based on confidence scores, resource requirements, and strategic value, ranking potential prefetch operations by expected benefit and probability of success, considering resource efficiency and cost-effectiveness of different prefetch options, applying user-specific and system-wide optimization criteria, and selecting optimal combinations of prefetch operations within resource constraints. Cache replacement candidates are evaluated to make room for new prefetch data when cache capacity is limited, analyzing existing cached data for replacement suitability based on access frequency, timing since last access, prediction probability for future access, and strategic value for system performance. Intelligent cache replacement policy is applied using algorithms that consider multiple factors including least recently used (LRU) patterns, least frequently used (LFU) patterns, prediction-based future access probability, and strategic value for overall system performance. Prefetch operations are initiated for high-priority predictions, coordinating with intelligent search engine 3404 and other system components to retrieve predicted data, implementing efficient retrieval strategies that minimize system impact, applying background processing techniques to avoid interference with active user queries, and monitoring prefetch progress to ensure successful completion.

At step 3909, prefetch operations are monitored and adapted based on system resources and performance requirements throughout the prefetch execution cycle. Progress monitoring tracks completion status of ongoing prefetch operations, measures resource utilization including memory, network, and computational resources, monitors system performance metrics to detect any degradation, and maintains awareness of changing system conditions that may require prefetch adjustment. Resource constraint detection monitors system performance indicators for signs of resource stress, evaluates whether prefetching is impacting user-facing operations, assesses whether system capacity has changed since prefetching began, and applies configurable thresholds for resource utilization and performance impact. When resource constraints are detected, prefetch operations are throttled or suspended to preserve system performance, reducing the intensity or scope of ongoing prefetch operations, implementing resource management policies that prioritize user-facing activities, applying graceful degradation techniques that maintain partial prefetching benefits, and preparing for resumption of full prefetching when resources become available. When no resource constraints are detected, prefetch operations continue until completion according to the original plan, maintaining the planned scope and intensity of prefetch operations and applying optimization techniques to maximize efficiency of remaining prefetch activities.

At step 3910, cache metadata and learning models are updated with comprehensive results from the prefetch operations and overall cache management cycle. Cache metadata updates record the success or failure of prefetch operations, update cache indexes and access information for prefetched data, maintain statistical information about prefetch effectiveness and accuracy, and prepare cache data for efficient future retrieval. Prediction outcomes are recorded for learning purposes, tracking whether prefetched data was subsequently requested by users, measuring the timing accuracy of predictions relative to actual user behavior, analyzing the effectiveness of different prediction strategies and algorithms, and identifying patterns in prediction success and failure. Access pattern models are updated based on prediction results and observed user behavior, incorporating feedback about prediction accuracy into statistical models, adjusting algorithms and parameters based on observed performance, refining user behavior profiles and workflow understanding, and enhancing prediction capabilities for similar future scenarios. Cache configuration parameters are adjusted based on performance results and system analysis, modifying cache size allocations and resource utilization policies, updating prefetch strategies and timing parameters, refining replacement policies and prioritization criteria, and optimizing cache management for observed usage patterns and system characteristics. The next cache analysis and optimization cycle is scheduled based on system activity levels, performance requirements, and available resources, determining appropriate intervals for future cache management activities and coordinating with system maintenance and optimization schedules.

At step 3907, when insufficient resources are available for prefetching, prediction models are updated without implementing prefetch operations to preserve learning benefits while avoiding resource conflicts. Model-only updates incorporate current query and context information into learned access patterns, maintain statistical models and user behavior profiles, prepare for future prefetching opportunities when resources become available, and ensure continuous learning despite temporary resource limitations. Model updates preserve learning momentum while respecting system resource constraints. Access pattern analysis continues to examine the current query in relation to user behavior patterns, identify potential follow-up queries based on historical access sequences, analyze session context to understand ongoing user workflows, and evaluate temporal patterns that may indicate future data needs. Statistical models are refined based on the current query data, updating user behavior profiles and temporal access patterns, maintaining prediction algorithm accuracy, and preparing enhanced prediction capabilities for future cache management cycles when resources permit full prefetching operations.

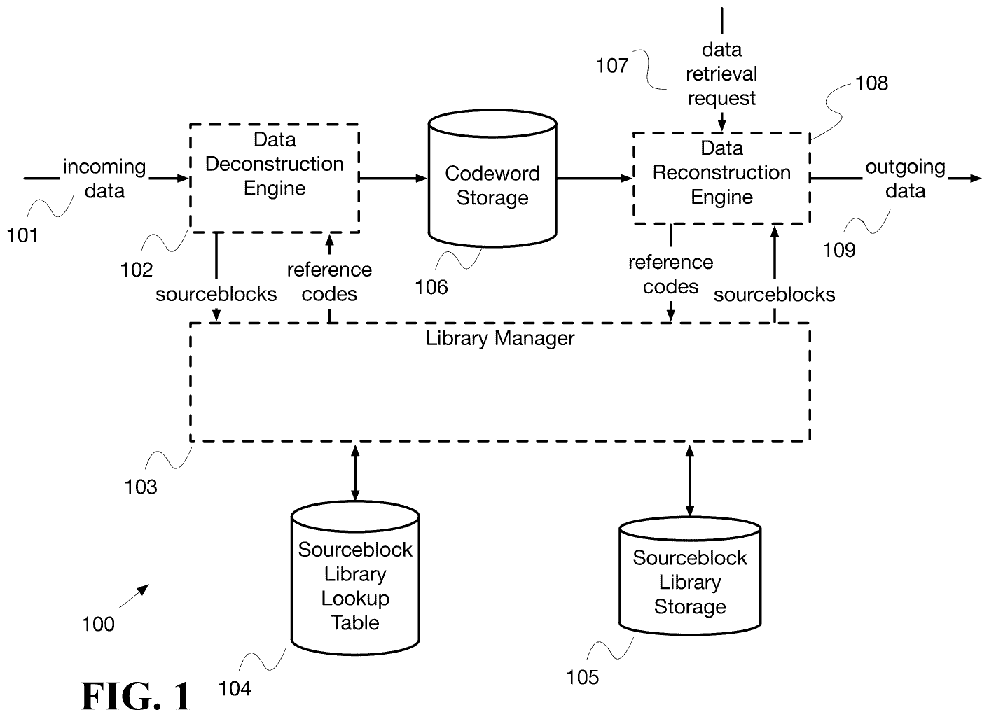

FIG. 1 is a diagram showing an embodiment 100 of the system in which all components of the system are operated locally. As incoming data 101 is received by data deconstruction engine 102. Data deconstruction engine 102 breaks the incoming data into sourceblocks, which are then sent to library manager 103. Using the information contained in sourceblock library lookup table 104 and sourceblock library storage 105, library manager 103 returns reference codes to data deconstruction engine 102 for processing into codewords, which are stored in codeword storage 106. When a data retrieval request 107 is received, data reconstruction engine 108 obtains the codewords associated with the data from codeword storage 106, and sends them to library manager 103. Library manager 103 returns the appropriate sourceblocks to data reconstruction engine 108, which assembles them into the proper order and sends out the data in its original form 109.

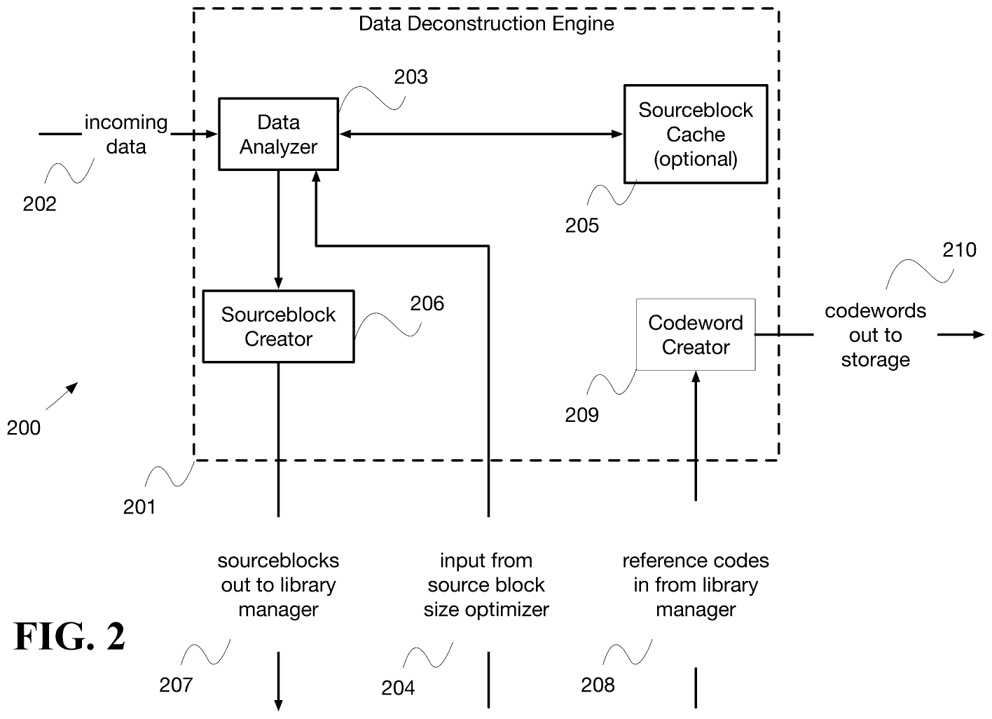

FIG. 2 is a diagram showing an embodiment of one aspect 200 of the system, specifically data deconstruction engine 201. Incoming data 202 is received by data analyzer 203, which optimally analyzes the data based on machine learning algorithms and input 204 from a sourceblock size optimizer, which is disclosed below. Data analyzer may optionally have access to a sourceblock cache 205 of recently-processed sourceblocks, which can increase the speed of the system by avoiding processing in library manager 103. Based on information from data analyzer 203, the data is broken into sourceblocks by sourceblock creator 206, which sends sourceblocks 207 to library manager 203 for additional processing. Data deconstruction engine 201 receives reference codes 208 from library manager 103, corresponding to the sourceblocks in the library that match the sourceblocks sent by sourceblock creator 206, and codeword creator 209 processes the reference codes into codewords comprising a reference code to a sourceblock and a location of that sourceblock within the data set. The original data may be discarded, and the codewords representing the data are sent out to storage 210.

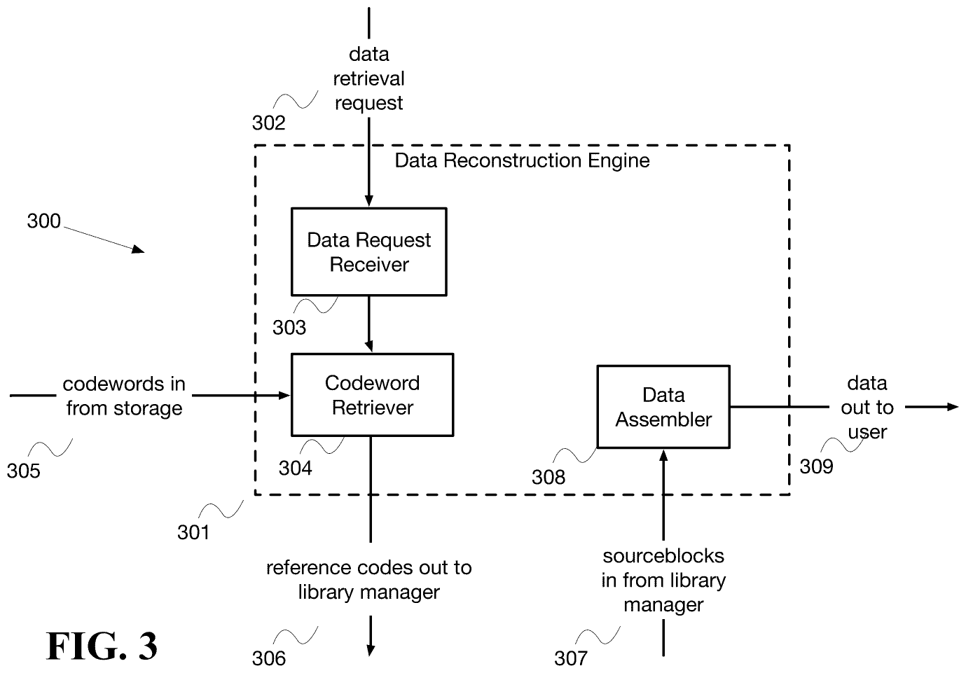

FIG. 3 is a diagram showing an embodiment of another aspect of system 300, specifically data reconstruction engine 301. When a data retrieval request 302 is received by data request receiver 303 (in the form of a plurality of codewords corresponding to a desired final data set), it passes the information to data retriever 304, which obtains the requested data 305 from storage. Data retriever 304 sends, for each codeword received, a reference codes from the codeword 306 to library manager 103 for retrieval of the specific sourceblock associated with the reference code. Data assembler 308 receives the sourceblock 307 from library manager 103 and, after receiving a plurality of sourceblocks corresponding to a plurality of codewords, assembles them into the proper order based on the location information contained in each codeword (recall each codeword comprises a sourceblock reference code and a location identifier that specifies where in the resulting data set the specific sourceblock should be restored to. The requested data is then sent to user 309 in its original form.

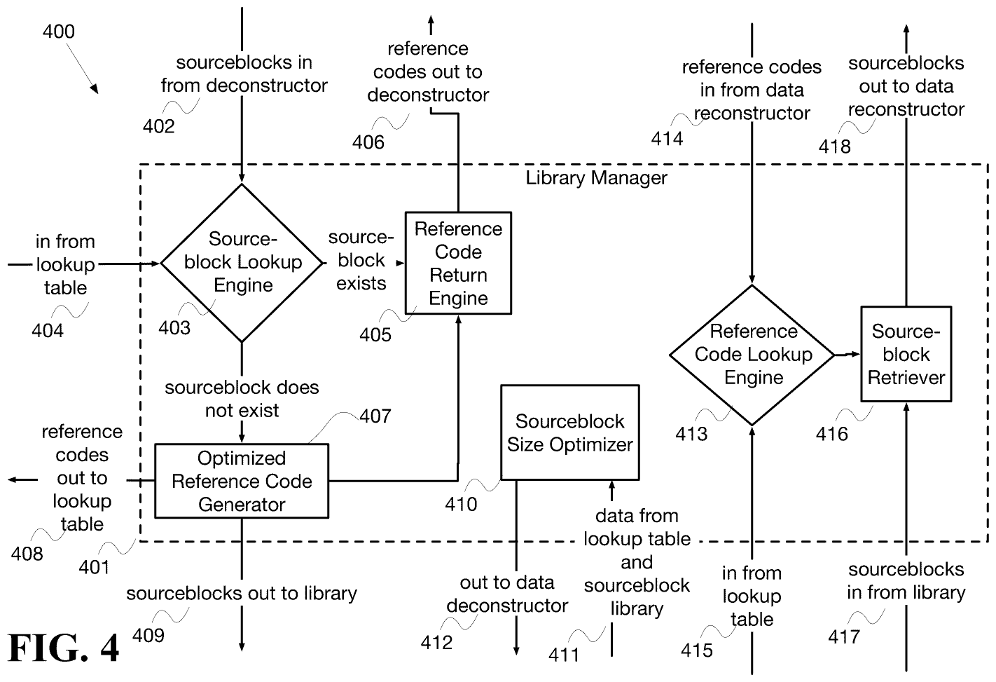

FIG. 4 is a diagram showing an embodiment of another aspect of the system 400, specifically library manager 401. One function of library manager 401 is to generate reference codes from sourceblocks received from data deconstruction engine 301. As sourceblocks are received 402 from data deconstruction engine 301, sourceblock lookup engine 403 checks sourceblock library lookup table 404 to determine whether those sourceblocks already exist in sourceblock library storage 105. If a particular sourceblock exists in sourceblock library storage 105, reference code return engine 405 sends the appropriate reference code 406 to data deconstruction engine 301. If the sourceblock does not exist in sourceblock library storage 105, optimized reference code generator 407 generates a new, optimized reference code based on machine learning algorithms. Optimized reference code generator 407 then saves the reference code 408 to sourceblock library lookup table 104; saves the associated sourceblock 409 to sourceblock library storage 105; and passes the reference code to reference code return engine 405 for sending 406 to data deconstruction engine 301. Another function of library manager 401 is to optimize the size of sourceblocks in the system. Based on information 411 contained in sourceblock library lookup table 104, sourceblock size optimizer 410 dynamically adjusts the size of sourceblocks in the system based on machine learning algorithms and outputs that information 412 to data analyzer 203. Another function of library manager 401 is to return sourceblocks associated with reference codes received from data reconstruction engine 301. As reference codes are received 414 from data reconstruction engine 301, reference code lookup engine 413 checks sourceblock library lookup table 415 to identify the associated sourceblocks; passes that information to sourceblock retriever 416, which obtains the sourceblocks 417 from sourceblock library storage 105; and passes them 418 to data reconstruction engine 301.

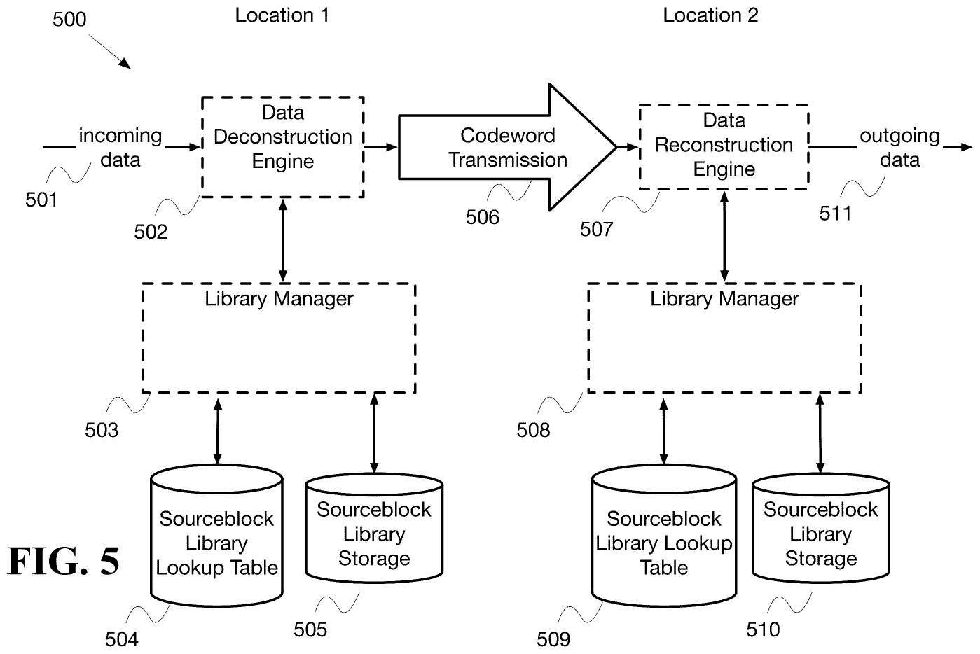

FIG. 5 is a diagram showing another embodiment of system 500, in which data is transferred between remote locations. As incoming data 501 is received by data deconstruction engine 502 at Location 1, data deconstruction engine 301 breaks the incoming data into sourceblocks, which are then sent to library manager 503 at Location 1. Using the information contained in sourceblock library lookup table 504 at Location 1 and sourceblock library storage 505 at Location 1, library manager 503 returns reference codes to data deconstruction engine 301 for processing into codewords, which are transmitted 506 to data reconstruction engine 507 at Location 2. In the case where the reference codes contained in a particular codeword have been newly generated by library manager 503 at Location 1, the codeword is transmitted along with a copy of the associated sourceblock. As data reconstruction engine 507 at Location 2 receives the codewords, it passes them to library manager module 508 at Location 2, which looks up the sourceblock in sourceblock library lookup table 509 at Location 2, and retrieves the associated from sourceblock library storage 510. Where a sourceblock has been transmitted along with a codeword, the sourceblock is stored in sourceblock library storage 510 and sourceblock library lookup table 504 is updated. Library manager 503 returns the appropriate sourceblocks to data reconstruction engine 507, which assembles them into the proper order and sends the data in its original form 511.

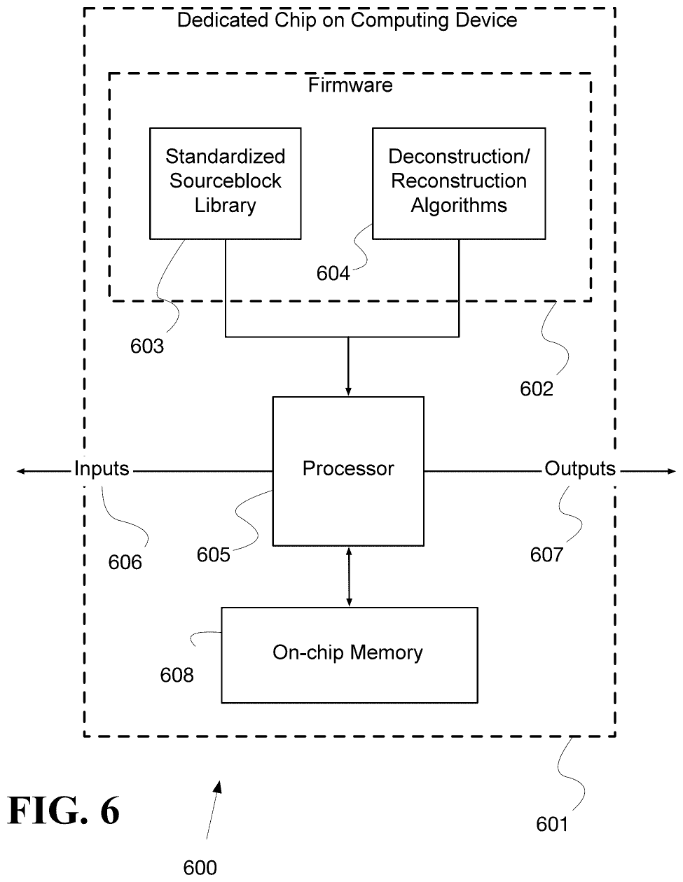

FIG. 6 is a diagram showing an embodiment 600 in which a standardized version of a sourceblock library 603 and associated algorithms 604 would be encoded as firmware 602 on a dedicated processing chip 601 included as part of the hardware of a plurality of devices 600. Contained on dedicated chip 601 would be a firmware area 602, on which would be stored a copy of a standardized sourceblock library 603 and deconstruction/reconstruction algorithms 604 for processing the data. Processor 605 would have both inputs 606 and outputs 607 to other hardware on the device 600. Processor 605 would store incoming data for processing on on-chip memory 608, process the data using standardized sourceblock library 603 and deconstruction/reconstruction algorithms 604, and send the processed data to other hardware on device 600. Using this embodiment, the encoding and decoding of data would be handled by dedicated chip 601, keeping the burden of data processing off device's 600 primary processors. Any device equipped with this embodiment would be able to store and transmit data in a highly optimized, bandwidth-efficient format with any other device equipped with this embodiment.

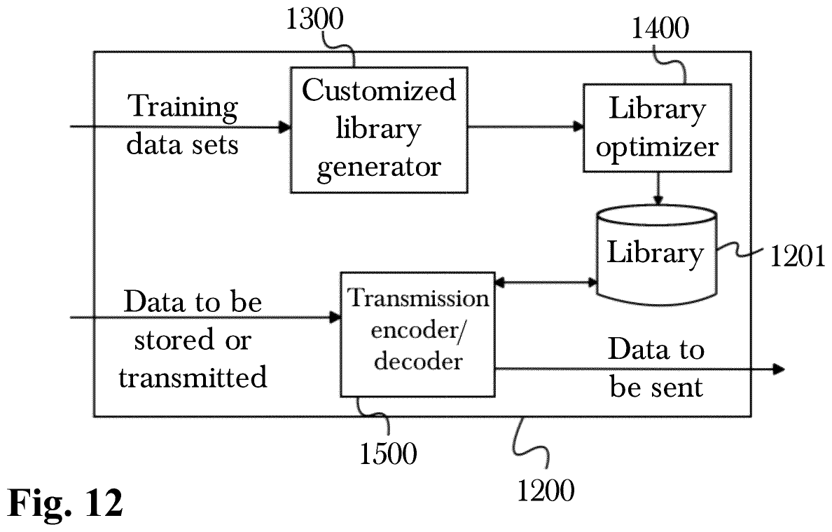

FIG. 12 is a diagram showing an exemplary system architecture 1200, according to a preferred embodiment of the invention. Incoming training data sets may be received at a customized library generator 1300 that processes training data to produce a customized word library 1201 comprising key-value pairs of data words (each comprising a string of bits) and their corresponding calculated binary Huffman codewords. The resultant word library 1201 may then be processed by a library optimizer 1400 to reduce size and improve efficiency, for example by pruning low-occurrence data entries or calculating approximate codewords that may be used to match more than one data word. A transmission encoder/decoder 1500 may be used to receive incoming data intended for storage or transmission, process the data using a word library 1201 to retrieve codewords for the words in the incoming data, and then append the codewords (rather than the original data) to an outbound data stream. Each of these components is described in greater detail below, illustrating the particulars of their respective processing and other functions, referring to FIGS. 2-4.

System 1200 provides near-instantaneous source coding that is dictionary-based and learned in advance from sample training data, so that encoding and decoding may happen concurrently with data transmission. This results in computational latency that is near zero but the data size reduction is comparable to classical compression. For example, if N bits are to be transmitted from sender to receiver, the compression ratio of classical compression is C, the ratio between the deflation factor of system 1200 and that of multi-pass source coding is p, the classical compression encoding rate is R_{C} bit/s and the decoding rate is R_{D} bit/s, and the transmission speed is S bit/s, the compress-send-decompress time will be

$${T}_{old} = \frac{N}{{R}_{C}} + \frac{N}{CS} + \frac{N}{{CR}_{D}}$$

while the transmit-while-coding time for system 1200 will be (assuming that encoding and decoding happen at least as quickly as network latency):

$${T}_{new} = \frac{{N}_{p}}{CS} so$$

that the total data transit time improvement factor is

$$\frac{{T}_{old}}{{T}_{new}} = \frac{\frac{CS}{{R}_{C}} + 1 + \frac{S}{{R}_{D}}}{p}$$

which presents a savings whenever

$$\frac{CS}{{R}_{C}} + \frac{S}{{R}_{D}} > p - 1.$$

This is a reasonable scenario given that typical values in real-world practice are C=0.32, R_{C}=1.1·10¹², R_{D}=4.2·10¹², S=10¹¹, giving

$$\frac{CS}{{R}_{C}} + \frac{S}{{R}_{D}} = 0.053 . .. ,$$

such that system 1200 will outperform the total transit time of the best compression technology available as long as its deflation factor is no more than 5% worse than compression. Such customized dictionary-based encoding will also sometimes exceed the deflation ratio of classical compression, particularly when network speeds increase beyond 100 Gb/s.

The delay between data creation and its readiness for use at a receiving end will be equal to only the source word length t (typically 5-15 bytes), divided by the deflation factor C/p and the network speed S, i.e.

$${delay}_{invention} = \frac{tp}{CS}$$

since encoding and decoding occur concurrently with data transmission. On the other hand, the latency associated with classical compression is

$${delay}_{priorart} = \frac{N}{{R}_{C}} + \frac{N}{CS} + \frac{N}{{CR}_{D}}$$

where N is the packet/file size. Even with the generous values chosen above as well as N=512K, t=10, and p=1.05, this results in delayᵢₙᵥₑₙₜᵢₒₙ˜3.3·10⁻¹⁰ while delayₚᵣᵢₒᵣₐᵣₜ˜1.3·10⁻⁷, a more than 400-fold reduction in latency.

A key factor in the efficiency of Huffman coding used by system 1200 is that key-value pairs be chosen carefully to minimize expected coding length, so that the average deflation/compression ratio is minimized. It is possible to achieve the best possible expected code length among all instantaneous codes using Huffman codes if one has access to the exact probability distribution of source words of a given desired length from the random variable generating them. In practice this is impossible, as data is received in a wide variety of formats and the random processes underlying the source data are a mixture of human input, unpredictable (though in principle, deterministic) physical events, and noise. System 1200 addresses this by restriction of data types and density estimation; training data is provided that is representative of the type of data anticipated in “real-world” use of system 1200, which is then used to model the distribution of binary strings in the data in order to build a Huffman code word library 1200.

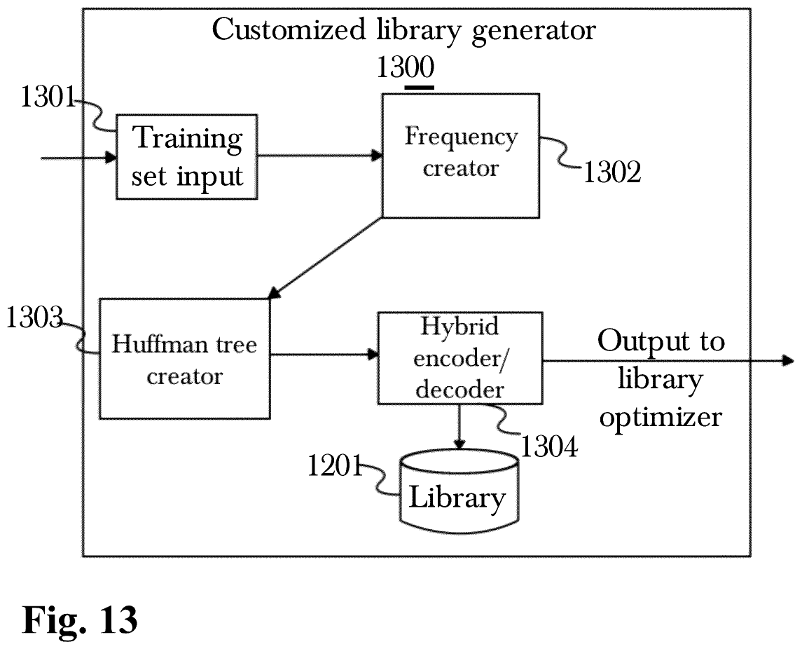

FIG. 13 is a diagram showing a more detailed architecture for a customized library generator 1300. When an incoming training data set 1301 is received, it may be analyzed using a frequency creator 1302 to analyze for word frequency (that is, the frequency with which a given word occurs in the training data set). Word frequency may be analyzed by scanning all substrings of bits and directly calculating the frequency of each substring by iterating over the data set to produce an occurrence frequency, which may then be used to estimate the rate of word occurrence in non-training data. A first Huffman binary tree is created based on the frequency of occurrences of each word in the first dataset, and a Huffman codeword is assigned to each observed word in the first dataset according to the first Huffman binary tree. Machine learning may be utilized to improve results by processing a number of training data sets and using the results of each training set to refine the frequency estimations for non-training data, so that the estimation yield better results when used with real-world data (rather than, for example, being only based on a single training data set that may not be very similar to a received non-training data set). A second Huffman tree creator 1303 may be utilized to identify words that do not match any existing entries in a word library 1201 and pass them to a hybrid encoder/decoder 1304, that then calculates a binary Huffman codeword for the mismatched word and adds the codeword and original data to the word library 1201 as a new key-value pair. In this manner, customized library generator 1300 may be used both to establish an initial word library 1201 from a first training set, as well as expand the word library 1201 using additional training data to improve operation.

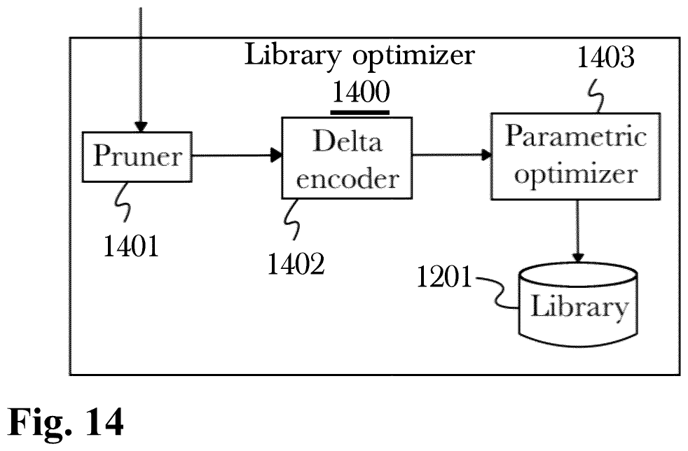

FIG. 14 is a diagram showing a more detailed architecture for a library optimizer 1400. A pruner 1401 may be used to load a word library 1201 and reduce its size for efficient operation, for example by sorting the word library 1201 based on the known occurrence probability of each key-value pair and removing low-probability key-value pairs based on a loaded threshold parameter. This prunes low-value data from the word library to trim the size, eliminating large quantities of very-low-frequency key-value pairs such as single-occurrence words that are unlikely to be encountered again in a data set. Pruning eliminates the least-probable entries from word library 1201 up to a given threshold, which will have a negligible impact on the deflation factor since the removed entries are only the least-common ones, while the impact on word library size will be larger because samples drawn from asymptotically normal distributions (such as the log-probabilities of words generated by a probabilistic finite state machine, a model well-suited to a wide variety of real-world data) which occur in tails of the distribution are disproportionately large in counting measure. A delta encoder 1402 may be utilized to apply delta encoding to a plurality of words to store an approximate codeword as a value in the word library, for which each of the plurality of source words is a valid corresponding key. This may be used to reduce library size by replacing numerous key-value pairs with a single entry for the approximate codeword and then represent actual codewords using the approximate codeword plus a delta value representing the difference between the approximate codeword and the actual codeword. Approximate coding is optimized for low-weight sources such as Golomb coding, run-length coding, and similar techniques. The approximate source words may be chosen by locality-sensitive hashing, so as to approximate Hamming distance without incurring the intractability of nearest-neighbor-search in Hamming space. A parametric optimizer 1403 may load configuration parameters for operation to optimize the use of the word library 1201 during operation. Best-practice parameter/hyperparameter optimization strategies such as stochastic gradient descent, quasi-random grid search, and evolutionary search may be used to make optimal choices for all interdependent settings playing a role in the functionality of system 1200. In cases where lossless compression is not required, the delta value may be discarded at the expense of introducing some limited errors into any decoded (reconstructed) data.

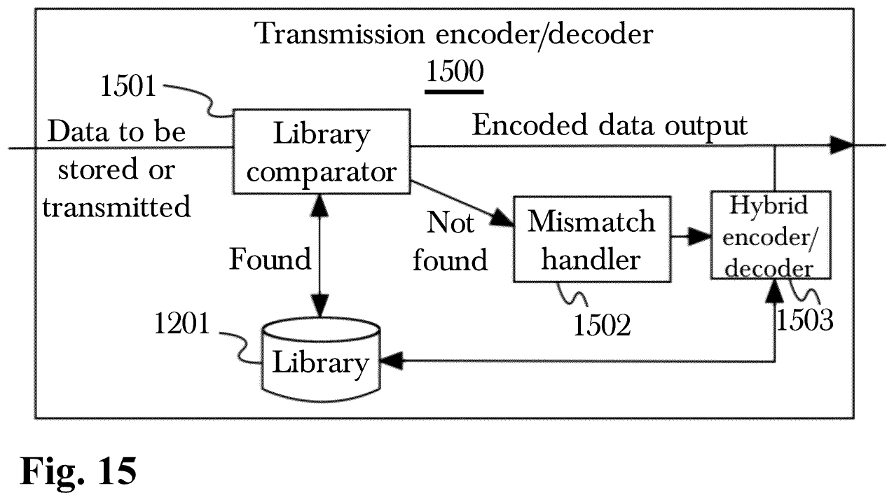

FIG. 15 is a diagram showing a more detailed architecture for a transmission encoder/decoder 1500. According to various arrangements, transmission encoder/decoder 1500 may be used to deconstruct data for storage or transmission, or to reconstruct data that has been received, using a word library 1201. A library comparator 1501 may be used to receive data comprising words or codewords, and compare against a word library 1201 by dividing the incoming stream into substrings of length t and using a fast hash to check word library 1201 for each substring. If a substring is found in word library 1201, the corresponding key/value (that is, the corresponding source word or codeword, according to whether the substring used in comparison was itself a word or codeword) is returned and appended to an output stream. If a given substring is not found in word library 1201, a mismatch handler 1502 and hybrid encoder/decoder 1503 may be used to handle the mismatch similarly to operation during the construction or expansion of word library 1201. A mismatch handler 1502 may be utilized to identify words that do not match any existing entries in a word library 1201 and pass them to a hybrid encoder/decoder 1503, that then calculates a binary Huffman codeword for the mismatched word and adds the codeword and original data to the word library 1201 as a new key-value pair. The newly-produced codeword may then be appended to the output stream. In arrangements where a mismatch indicator is included in a received data stream, this may be used to preemptively identify a substring that is not in word library 1201 (for example, if it was identified as a mismatch on the transmission end), and handled accordingly without the need for a library lookup.

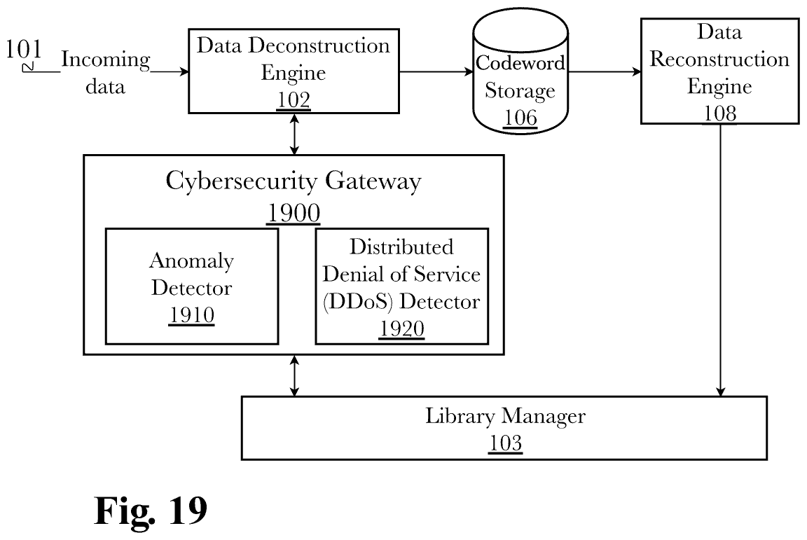

FIG. 19 is an exemplary system architecture of a data encoding system used for cyber security purposes. Much like in FIG. 1, incoming data 101 to be deconstructed is sent to a data deconstruction engine 102, which may attempt to deconstruct the data and turn it into a collection of codewords using a library manager 103. Codeword storage 106 serves to store unique codewords from this process, and may be queried by a data reconstruction engine 108 which may reconstruct the original data from the codewords, using a library manager 103. However, a cybersecurity gateway 1900 is present, communicating in-between a library manager 103 and a deconstruction engine 102, and containing an anomaly detector 1910 and distributed denial of service (DDoS) detector 1920. The anomaly detector examines incoming data to determine whether there is a disproportionate number of incoming reference codes that do not match reference codes in the existing library. A disproportionate number of non-matching reference codes may indicate that data is being received from an unknown source, of an unknown type, or contains unexpected (possibly malicious) data. If the disproportionate number of non-matching reference codes exceeds an established threshold or persists for a certain length of time, the anomaly detector 1910 raises a warning to a system administrator. Likewise, the DDOS detector 1920 examines incoming data to determine whether there is a disproportionate amount of repetitive data. A disproportionate amount of repetitive data may indicate that a DDOS attack is in progress. If the disproportionate amount of repetitive data exceeds an established threshold or persists for a certain length of time, the DDOS detector 1910 raises a warning to a system administrator. In this way, a data encoding system may detect and warn users of, or help mitigate, common cyber-attacks that result from a flow of unexpected and potentially harmful data, or attacks that result from a flow of too much irrelevant data meant to slow down a network or system, as in the case of a DDOS attack.

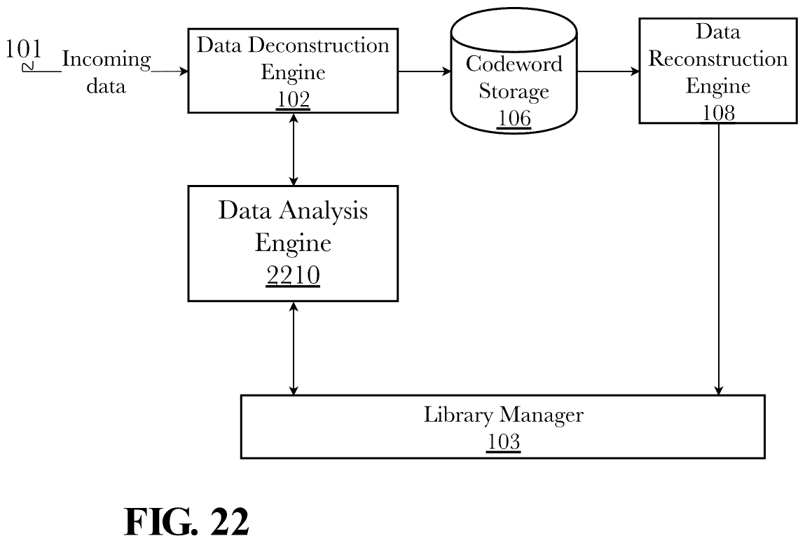

FIG. 22 is an exemplary system architecture of a data encoding system used for data mining and analysis purposes. Much like in FIG. 1, incoming data 101 to be deconstructed is sent to a data deconstruction engine 102, which may attempt to deconstruct the data and turn it into a collection of codewords using a library manager 103. Codeword storage 106 serves to store unique codewords from this process, and may be queried by a data reconstruction engine 108 which may reconstruct the original data from the codewords, using a library manager 103. A data analysis engine 2210, typically operating while the system is otherwise idle, sends requests for data to the data reconstruction engine 108, which retrieves the codewords representing the requested data from codeword storage 106, reconstructs them into the data represented by the codewords, and send the reconstructed data to the data analysis engine 2210 for analysis and extraction of useful data (i.e., data mining). Because the speed of reconstruction is significantly faster than decompression using traditional compression technologies (i.e., significantly less decompression latency), this approach makes data mining feasible. Very often, data stored using traditional compression is not mined precisely because decompression lag makes it unfeasible, especially during shorter periods of system idleness. Increasing the speed of data reconstruction broadens the circumstances under which data mining of stored data is feasible.

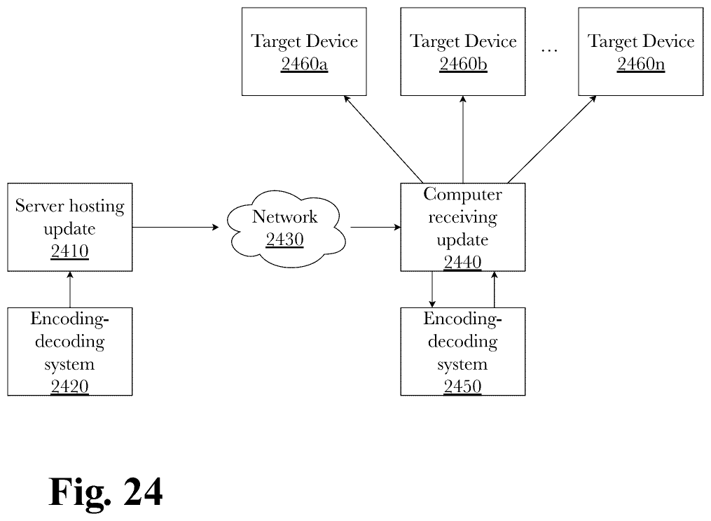

FIG. 24 is an exemplary system architecture of a data encoding system used for remote software and firmware updates. Software and firmware updates typically require smaller, but more frequent, file transfers. A server which hosts a software or firmware update 2410 may host an encoding-decoding system 2420, allowing for data to be encoded into, and decoded from, sourceblocks or codewords, as disclosed in previous figures. Such a server may possess a software update, operating system update, firmware update, device driver update, or any other form of software update, which in some cases may be minor changes to a file, but nevertheless necessitate sending the new, completed file to the recipient. Such a server is connected over a network 2430, which is further connected to a recipient computer 2440, which may be connected to a server 2410 for receiving such an update to its system. In this instance, the recipient device 2440 also hosts the encoding and decoding system 2450, along with a codebook or library of reference codes that the hosting server 2410 also shares. The updates are retrieved from storage at the hosting server 2410 in the form of codewords, transferred over the network 2430 in the form of codewords, and reconstructed on the receiving computer 2440. In this way, a far smaller file size, and smaller total update size, may be sent over a network. The receiving computer 2440 may then install the updates on any number of target computing devices 2460a-n, using a local network or other high-bandwidth connection.

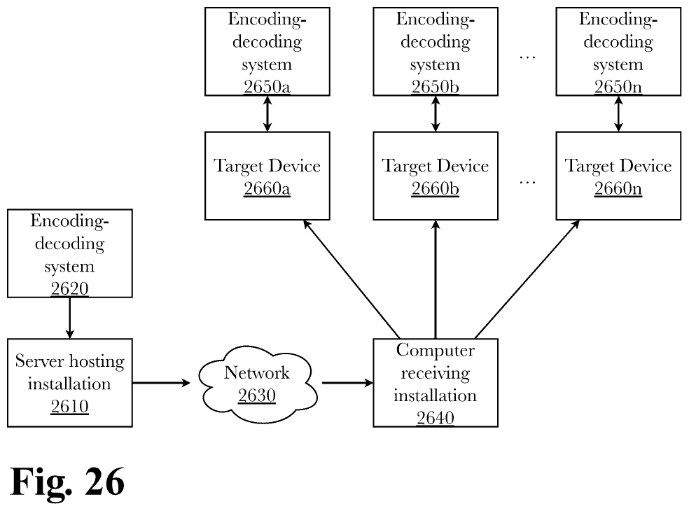

FIG. 26 is an exemplary system architecture of a data encoding system used for large-scale software installation such as operating systems. Large-scale software installations typically require very large, but infrequent, file transfers. A server which hosts an installable software 2610 may host an encoding-decoding system 2620, allowing for data to be encoded into, and decoded from, sourceblocks or codewords, as disclosed in previous figures. The files for the large scale software installation are hosted on the server 2610, which is connected over a network 2630 to a recipient computer 2640. In this instance, the encoding and decoding system 2650a-n is stored on or connected to one or more target devices 2660a-n, along with a codebook or library of reference codes that the hosting server 2610 shares. The software is retrieved from storage at the hosting server 2610 in the form of codewords, and transferred over the network 2630 in the form of codewords to the receiving computer 2640. However, instead of being reconstructed at the receiving computer 2640, the codewords are transmitted to one or more target computing devices, and reconstructed and installed directly on the target devices 2660a-n. In this way, a far smaller file size, and smaller total update size, may be sent over a network or transferred between computing devices, even where the network 2630 between the receiving computer 2640 and target devices 2660a-n is low bandwidth, or where there are many target devices 2660a-n.

FIG. 28 is an exemplary system architecture of a data encoding system with random access capabilities. Much like in FIG. 1, incoming data 101 to be deconstructed is sent to a data deconstruction engine 102, which may attempt to deconstruct the data and turn it into a collection of codewords using a library manager 103. Codeword storage 106 serves to store unique codewords from this process, and may be queried by a data reconstruction engine 108 which may reconstruct the original data from the codewords, using a library manager 103. However, a random-access engine 2800 exists that receives a data query request from a user interface 2810 such as a graphical user interface. The query request may comprise identification of a compacted data file to search and a search term, and optionally a location hint. Various possible search term configurations may exist such as a byte range (i.e. begin at byte N and return M number of bytes), a string such as “volleyball” or a date such as “Nov. 6, 2020”, among others. The random access engine 2800 may also query the library manager 103 for retrieval of the reference codebook corresponding to the identified compacted data file. Additionally, the random access engine 2800 may query the codeword storage 106 for retrieval of a plurality of codewords, the plurality of codewords representing the compacted data file to be searched and read from. When the search term has been found, it may be sent to the data reconstruction engine 108 where it may be decoded to recover the original data, and the original data may be sent to the user interface 2810. The user may verify the search result is correct. If the result is incorrect the user may refine and submit a new search request.

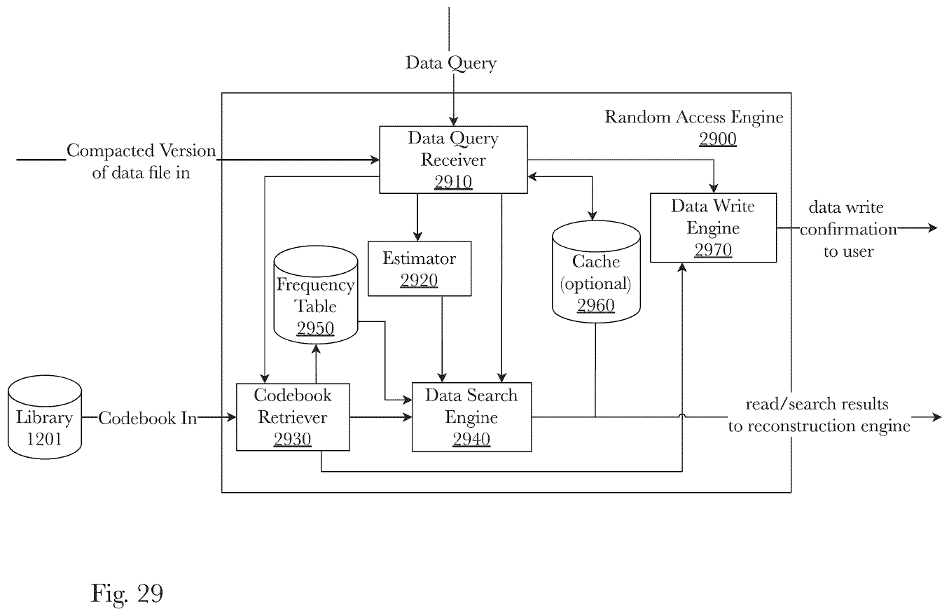

FIG. 29 is a diagram showing an embodiment of one aspect of the system, the random access engine 2900. The process begins when a data query request is made to the application. A data read query may comprise identification of a compacted data file to access, a search term, and optionally a location hint serving as an initial guess as to the location of the search term within the original data file. As a simple example of a data read query, the user searches for the string “cosmology” in a compacted data file “Y” to read from, and a location hint of byte “N” to be used to estimate where in “Y” the string “cosmology” may occur. Additionally, the random access engine 2900 may receive a data write query which may include the write term to be written and an identified compacted data file in which to write the write term. A data query receiver 2910 parses both data read and data write queries and retrieves the identified compacted data file in the form of a plurality of codewords from codeword storage 106. The data query receiver 2910 then sends the retrieved compacted data file and the search term to the data search engine 2940. If the data search query includes a location hint, then the query receiver 2910 may send the location hint to an estimator 2920. A location hint may be given that represents where in the original file the data to be read may be located, and the estimator receives the location hint and estimates that same location in the compacted version of the data file. A location hint may comprise a byte location N in the original file X, the estimator 2920 estimates the location (bit number) N′ in Y (compacted version of data file) corresponding to byte N in X. The estimator 2920 may check if the estimated location N′ is located at a codeword boundary or in the middle of a codeword. If N′ lies within a codeword, then the estimator may use bit-scrolling backward and forward to find the codeword boundary. Additionally, the location hint may comprise a user command such as “start at the 45% mark”. The estimator 2920 sends the estimated location of the byte range to the data search engine 2940 for further processing.

A codebook retriever 2930 receives a signal form the data query receiver 2910 that prompts the codebook retriever 2930 to request the codebook and frequency table associated with the compacted data file from a word library 1201. The frequency table 2950 shows the most frequently occurring words or substrings within a data set, and may be used by the data search engine 2940 to refine the location estimate.

The data search engine 2940 receives a data read request in the form of a search term such as a byte range, string, or substring, and may receive an initial location estimate from the estimator 2920 if a location hint was included in the data read query. The data search engine 2940 may use a frequency table 2950 to refine location estimates and identify codeword boundaries in an automatic way. The estimated location may be in the middle of a codeword. If this is the case then the search results will return output that does not match the search query. For example, the search results return a sequence of bytes, the frequency table 2950 may be used to identify whether the sequence of bytes are unlikely to occur in the original data, or if the sequence was reasonably likely then a codeword boundary has probably been found. When a codeword boundary is found, it allows the whole compacted data file to be accessed in any order by jumping from codeword to codeword, facilitating useful search results. If the data request is in a string format and a location hint was provided, then the data search engine 2940 may automatically locate the search string via a binary search from the estimated starting point or a found codeword boundary. The data search engine 2940 may also parse a search term string into sourceblocks and create at least one or more encodings for sub-search strings derived from the original search string. An exemplary parsing process is discussed in more detail in FIG. 33 contained within this disclosure. Additionally, various search operators may be integrated into the search capabilities. A few examples of search operators include “near”, “and”, “or”, and “not”. These may be used to narrow the scope of the search. Once the byte range or search string has been located, the codebook may be used to decode the located reference codes belonging to the search string or byte range. In other embodiments, the located reference codes may be sent to the data reconstruction engine 108 which sends the decoded byte range or search string to the user for verification.

A search cache 2960 may optionally be used to store previous search terms and their locations within the compacted data file. The data query receiver 2910 may look for the requested data in the cache 2960 and if it is found in the cache then its location is sent to the data reconstruction engine 108 where the compacted data may be reconstructed and then sent to the user for review.

If the data query is a data write query, then the data query receiver 2910 may send a signal to the codebook retriever 2930 to retrieve the codebook corresponding to the identified compacted version of the data file in which the write term is to be written and send the write term to a data write engine 2970. The codebook retriever 2930 sends the codebook to the data write engine 2970. If the size of the data to be written (write term) is exactly the length of the sourceblock (sourceblock), then the data write engine 2970 can simply encode the data and insert it into the received codebook. More likely, the size of the data to be written does not exactly match the sourceblock length, and simply encoding and adding the codeword to the codebook would modify the output of the codewords globally, basically changing everything from that point on. In an embodiment, when some data is to be inserted into the original data file, the original file may be entirely re-encoded. In another embodiment, instead of re-encoding the entire file, an opcode is created that tells the decoder there is an offset that has to be accounted for when reconstructing the compacted data. In yet another embodiment, instead of using an opcode, there are extra unused bits available in the codebook that can be used to encode information about how many secondary bytes are coming up. A secondary byte(s) represent the newly written data that may be encoded and inserted in the codebook. In this way when encoded bit is found, the data encoder can switch to secondary encoding, encode one fewer byte, then resume normal encoding. This allows for inserting data into the original data file without having to re-encode the entire file.

### Description of Method Aspects

Since the library consists of re-usable building sourceblocks, and the actual data is represented by reference codes to the library, the total storage space of a single set of data would be much smaller than conventional methods, wherein the data is stored in its entirety. The more data sets that are stored, the larger the library becomes, and the more data can be stored in reference code form.

As an analogy, imagine each data set as a collection of printed books that are only occasionally accessed. The amount of physical shelf space required to store many collections would be quite large, and is analogous to conventional methods of storing every single bit of data in every data set. Consider, however, storing all common elements within and across books in a single library, and storing the books as references codes to those common elements in that library. As a single book is added to the library, it will contain many repetitions of words and phrases. Instead of storing the whole words and phrases, they are added to a library, and given a reference code, and stored as reference codes. At this scale, some space savings may be achieved, but the reference codes will be on the order of the same size as the words themselves. As more books are added to the library, larger phrases, quotations, and other words patterns will become common among the books. The larger the word patterns, the smaller the reference codes will be in relation to them as not all possible word patterns will be used. As entire collections of books are added to the library, sentences, paragraphs, pages, or even whole books will become repetitive. There may be many duplicates of books within a collection and across multiple collections, many references and quotations from one book to another, and much common phraseology within books on particular subjects. If each unique page of a book is stored only once in a common library and given a reference code, then a book of 1,000 pages or more could be stored on a few printed pages as a string of codes referencing the proper full-sized pages in the common library. The physical space taken up by the books would be dramatically reduced. The more collections that are added, the greater the likelihood that phrases, paragraphs, pages, or entire books will already be in the library, and the more information in each collection of books can be stored in reference form. Accessing entire collections of books is then limited not by physical shelf space, but by the ability to reprint and recycle the books as needed for use.

The projected increase in storage capacity using the method herein described is primarily dependent on two factors: 1) the ratio of the number of bits in a block to the number of bits in the reference code, and 2) the amount of repetition in data being stored by the system.

With respect to the first factor, the number of bits used in the reference codes to the sourceblocks must be smaller than the number of bits in the sourceblocks themselves in order for any additional data storage capacity to be obtained. As a simple example, 16-bit sourceblocks would require 216, or 65536, unique reference codes to represent all possible patterns of bits. If all possible 65536 blocks patterns are utilized, then the reference code itself would also need to contain sixteen bits in order to refer to all possible 65,536 blocks patterns. In such case, there would be no storage savings. However, if only 16 of those block patterns are utilized, the reference code can be reduced to 4 bits in size, representing an effective compression of 4 times (16 bits/4 bits=4) versus conventional storage. Using a typical block size of 512 bytes, or 4,096 bits, the number of possible block patterns is 24.09%, which for all practical purposes is unlimited. A typical hard drive contains one terabyte (TB) of physical storage capacity, which represents 1,953,125,000, or roughly 231, 512 byte blocks. Assuming that 1 TB of unique 512-byte sourceblocks were contained in the library, and that the reference code would thus need to be 31 bits long, the effective compression ratio for stored data would be on the order of 132 times (4,096/31≈132) that of conventional storage.

With respect to the second factor, in most cases it could be assumed that there would be sufficient repetition within a data set such that, when the data set is broken down into sourceblocks, its size within the library would be smaller than the original data. However, it is conceivable that the initial copy of a data set could require somewhat more storage space than the data stored in a conventional manner, if all or nearly all sourceblocks in that set were unique. For example, assuming that the reference codes are 1/10^{th} the size of a full-sized copy, the first copy stored as sourceblocks in the library would need to be 1.1 megabytes (MB), (1 MB for the complete set of full-sized sourceblocks in the library and 0.1 MB for the reference codes). However, since the sourceblocks stored in the library are universal, the more duplicate copies of something you save, the greater efficiency versus conventional storage methods. Conventionally, storing 10 copies of the same data requires 10 times the storage space of a single copy. For example, ten copies of a 1 MB file would take up 10 MB of storage space. However, using the method described herein, only a single full-sized copy is stored, and subsequent copies are stored as reference codes. Each additional copy takes up only a fraction of the space of the full-sized copy. For example, again assuming that the reference codes are 1/10th the size of the full-size copy, ten copies of a 1 MB file would take up only 2 MB of space (1 MB for the full-sized copy, and 0.1 MB each for ten sets of reference codes). The larger the library, the more likely that part or all of incoming data will duplicate sourceblocks already existing in the library.

The size of the library could be reduced in a manner similar to storage of data. Where sourceblocks differ from each other only by a certain number of bits, instead of storing a new sourceblock that is very similar to one already existing in the library, the new sourceblock could be represented as a reference code to the existing sourceblock, plus information about which bits in the new block differ from the existing block. For example, in the case where 512 byte sourceblocks are being used, if the system receives a new sourceblock that differs by only one bit from a sourceblock already existing in the library, instead of storing a new 512 byte sourceblock, the new sourceblock could be stored as a reference code to the existing sourceblock, plus a reference to the bit that differs. Storing the new sourceblock as a reference code plus changes would require only a few bytes of physical storage space versus the 512 bytes that a full sourceblock would require. The algorithm could be optimized to store new sourceblocks in this reference code plus changes form unless the changes portion is large enough that it is more efficient to store a new, full sourceblock.

It will be understood by one skilled in the art that transfer and synchronization of data would be increased to the same extent as for storage. By transferring or synchronizing reference codes instead of full-sized data, the bandwidth requirements for both types of operations are dramatically reduced.

In addition, the method described herein is inherently a form of encryption. When the data is converted from its full form to reference codes, none of the original data is contained in the reference codes. Without access to the library of sourceblocks, it would be impossible to re-construct any portion of the data from the reference codes. This inherent property of the method described herein could obviate the need for traditional encryption algorithms, thereby offsetting most or all of the computational cost of conversion of data back and forth to reference codes. In theory, the method described herein should not utilize any additional computing power beyond traditional storage using encryption algorithms. Alternatively, the method described herein could be in addition to other encryption algorithms to increase data security even further.

In other embodiments, additional security features could be added, such as: creating a proprietary library of sourceblocks for proprietary networks, physical separation of the reference codes from the library of sourceblocks, storage of the library of sourceblocks on a removable device to enable easy physical separation of the library and reference codes from any network, and incorporation of proprietary sequences of how sourceblocks are read and the data reassembled.

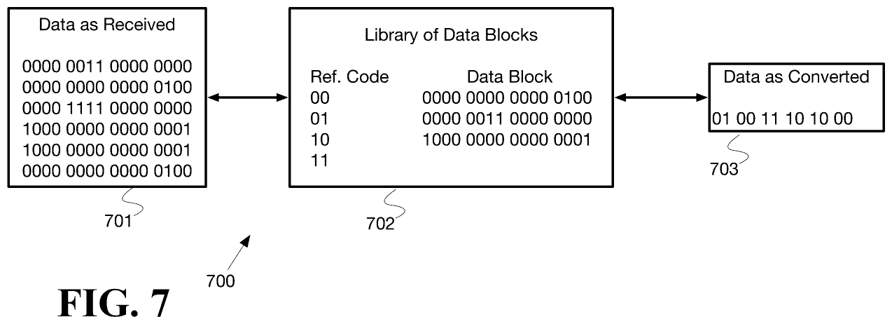

FIG. 7 is a diagram showing an example of how data might be converted into reference codes using an aspect of an embodiment 700. As data is received 701, it is read by the processor in sourceblocks of a size dynamically determined by the previously disclosed sourceblock size optimizer 410. In this example, each sourceblock is 16 bits in length, and the library 702 initially contains three sourceblocks with reference codes 00, 01, and 10. The entry for reference code 11 is initially empty. As each 16 bit sourceblock is received, it is compared with the library. If that sourceblock is already contained in the library, it is assigned the corresponding reference code. So, for example, as the first line of data (0000 0011 0000 0000) is received, it is assigned the reference code (01) associated with that sourceblock in the library. If that sourceblock is not already contained in the library, as is the case with the third line of data (0000 1111 0000 0000) received in the example, that sourceblock is added to the library and assigned a reference code, in this case 11. The data is thus converted 703 to a series of reference codes to sourceblocks in the library. The data is stored as a collection of codewords, each of which contains the reference code to a sourceblock and information about the location of the sourceblocks in the data set. Reconstructing the data is performed by reversing the process. Each stored reference code in a data collection is compared with the reference codes in the library, the corresponding sourceblock is read from the library, and the data is reconstructed into its original form.

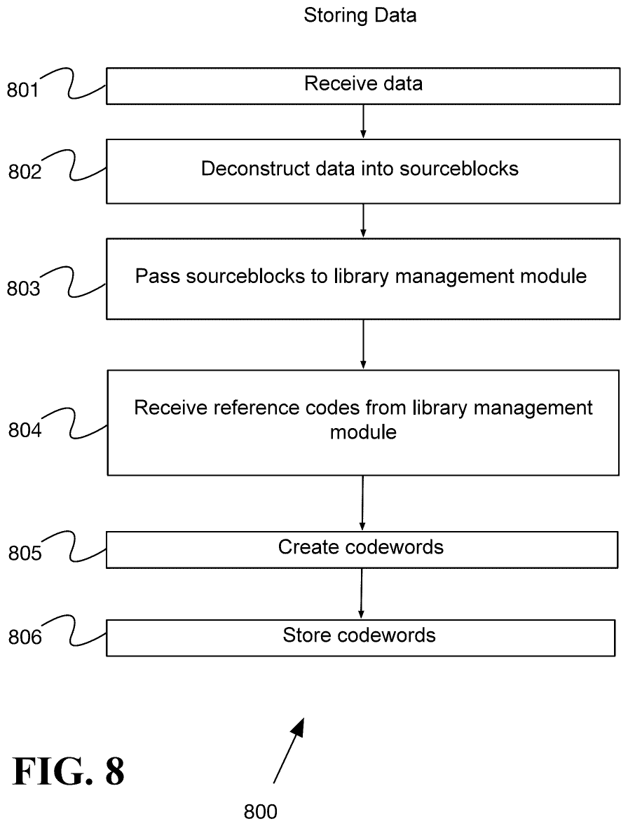

FIG. 8 is a method diagram showing the steps involved in using an embodiment 800 to store data. As data is received 801, it would be deconstructed into sourceblocks 802, and passed 803 to the library management module for processing. Reference codes would be received back 804 from the library management module, and could be combined with location information to create codewords 805, which would then be stored 806 as representations of the original data.

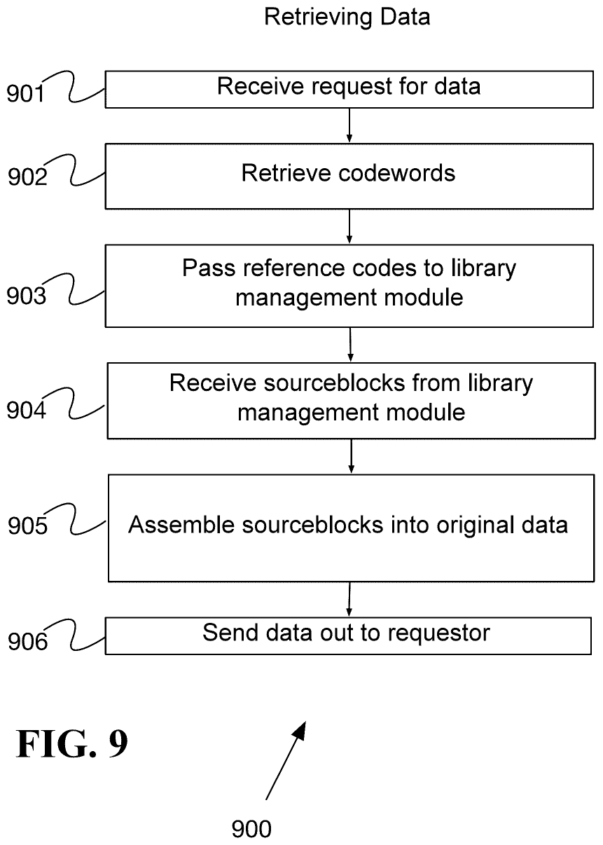

FIG. 9 is a method diagram showing the steps involved in using an embodiment 900 to retrieve data. When a request for data is received 901, the associated codewords would be retrieved 902 from the library. The codewords would be passed 903 to the library management module, and the associated sourceblocks would be received back 904. Upon receipt, the sourceblocks would be assembled 905 into the original data using the location data contained in the codewords, and the reconstructed data would be sent out 906 to the requestor.

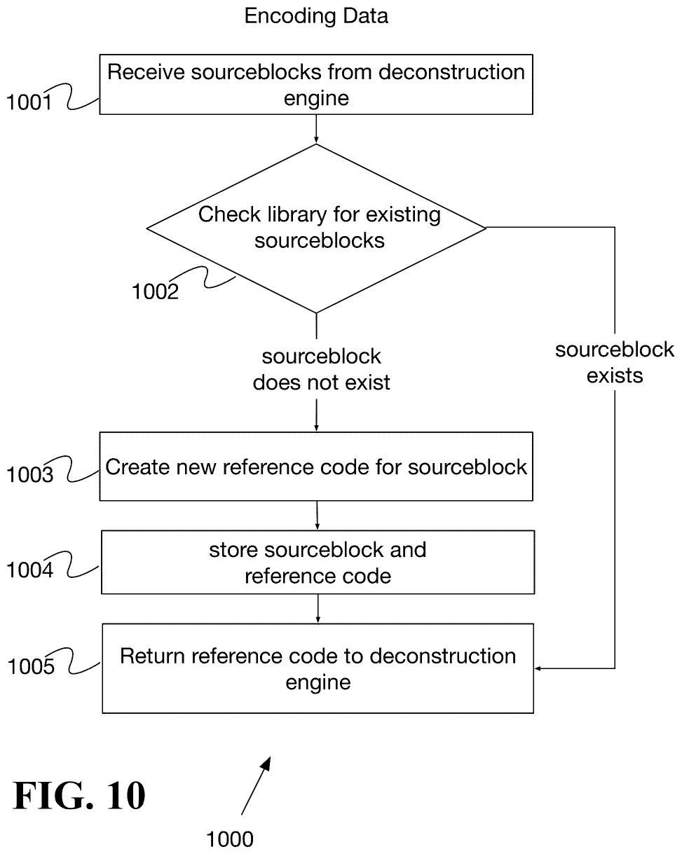

FIG. 10 is a method diagram showing the steps involved in using an embodiment 1000 to encode data. As sourceblocks are received 1001 from the deconstruction engine, they would be compared 1002 with the sourceblocks already contained in the library. If that sourceblock already exists in the library, the associated reference code would be returned 1005 to the deconstruction engine. If the sourceblock does not already exist in the library, a new reference code would be created 1003 for the sourceblock. The new reference code and its associated sourceblock would be stored 1004 in the library, and the reference code would be returned to the deconstruction engine.

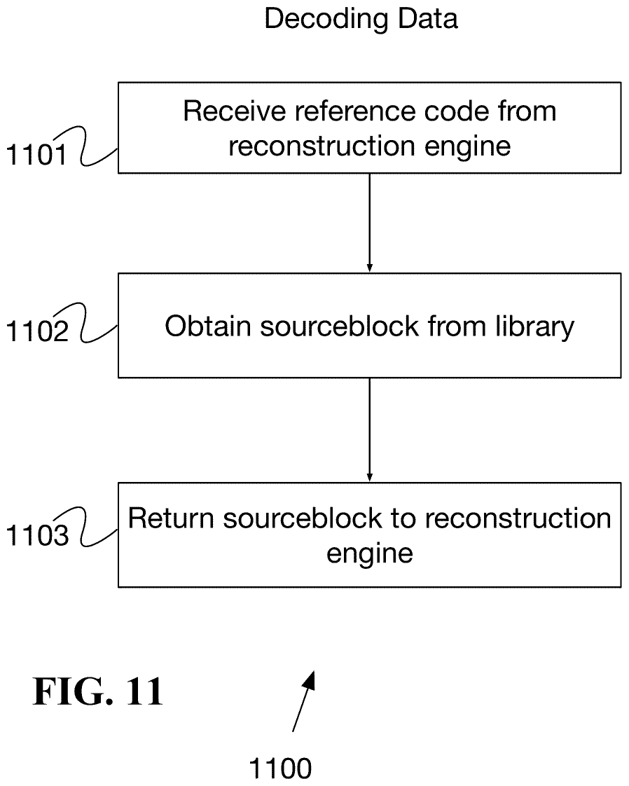

FIG. 11 is a method diagram showing the steps involved in using an embodiment 1100 to decode data. As reference codes are received 1101 from the reconstruction engine, the associated sourceblocks are retrieved 1102 from the library, and returned 1103 to the reconstruction engine.

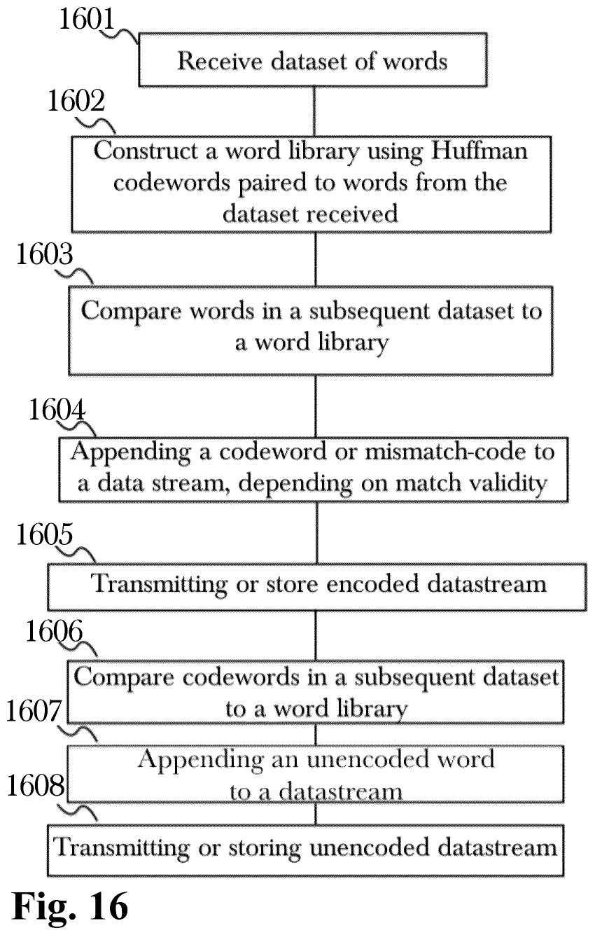

FIG. 16 is a method diagram illustrating key system functionality utilizing an encoder and decoder pair, according to a preferred embodiment. In a first step 1601, at least one incoming data set may be received at a customized library generator 1300 that then 1602 processes data to produce a customized word library 1201 comprising key-value pairs of data words (each comprising a string of bits) and their corresponding calculated binary Huffman codewords. A subsequent dataset may be received, and compared to the word library 1603 to determine the proper codewords to use in order to encode the dataset. Words in the dataset are checked against the word library and appropriate encodings are appended to a data stream 1604. If a word is mismatched within the word library and the dataset, meaning that it is present in the dataset but not the word library, then a mismatched code is appended, followed by the unencoded original word. If a word has a match within the word library, then the appropriate codeword in the word library is appended to the data stream. Such a data stream may then be stored or transmitted 1605 to a destination as desired. For the purposes of decoding, an already-encoded data stream may be received and compared 1606, and un-encoded words may be appended to a new data stream 1607 depending on word matches found between the encoded data stream and the word library that is present. A matching codeword that is found in a word library is replaced with the matching word and appended to a data stream, and a mismatch code found in a data stream is deleted and the following unencoded word is re-appended to a new data stream, the inverse of the process of encoding described earlier. Such a data stream may then be stored or transmitted 1608 as desired.

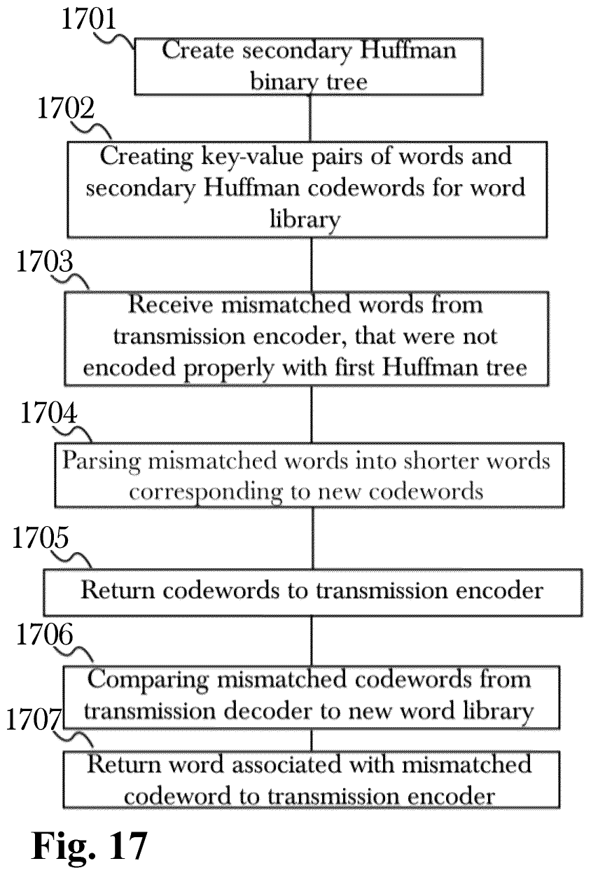

FIG. 17 is a method diagram illustrating possible use of a hybrid encoder/decoder to improve the compression ratio, according to a preferred aspect. A second Huffman binary tree may be created 1701, having a shorter maximum length of codewords than a first Huffman binary tree 1602, allowing a word library to be filled with every combination of codeword possible in this shorter Huffman binary tree 1702. A word library may be filled with these Huffman codewords and words from a dataset 1702, such that a hybrid encoder/decoder 1304, 1503 may receive any mismatched words from a dataset for which encoding has been attempted with a first Huffman binary tree 1703, 1604 and parse previously mismatched words into new partial codewords (that is, codewords that are each a substring of an original mismatched codeword) using the second Huffman binary tree 1704. In this way, an incomplete word library may be supplemented by a second word library. New codewords attained in this way may then be returned to a transmission encoder 1705, 1500. In the event that an encoded dataset is received for decoding, and there is a mismatch code indicating that additional coding is needed, a mismatch code may be removed and the unencoded word used to generate a new codeword as before 1706, so that a transmission encoder 1500 may have the word and newly generated codeword added to its word library 1707, to prevent further mismatching and errors in encoding and decoding.

It will be recognized by a person skilled in the art that the methods described herein can be applied to data in any form. For example, the method described herein could be used to store genetic data, which has four data units: C, G, A, and T. Those four data units can be represented as 2 bit sequences: 00, 01, 10, and 11, which can be processed and stored using the method described herein.

It will be recognized by a person skilled in the art that certain embodiments of the methods described herein may have uses other than data storage. For example, because the data is stored in reference code form, it cannot be reconstructed without the availability of the library of sourceblocks. This is effectively a form of encryption, which could be used for cyber security purposes. As another example, an embodiment of the method described herein could be used to store backup copies of data, provide for redundancy in the event of server failure, or provide additional security against cyberattacks by distributing multiple partial copies of the library among computers are various locations, ensuring that at least two copies of each sourceblock exist in different locations within the network.

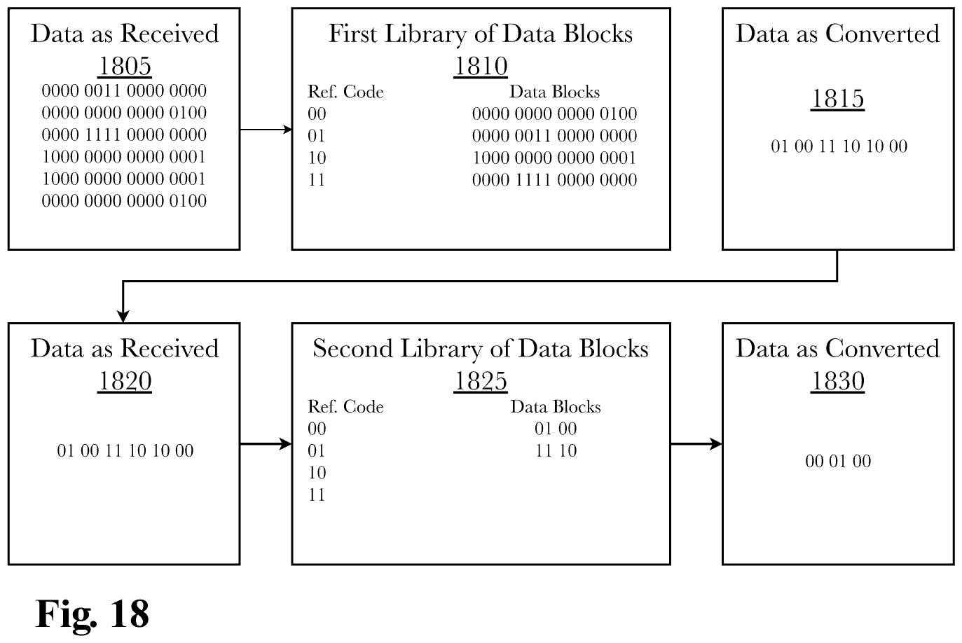

FIG. 18 is a flow diagram illustrating the use of a data encoding system used to recursively encode data to further reduce data size. Data may be input 1805 into a data deconstruction engine 102 to be deconstructed into code references, using a library of code references based on the input 1810. Such example data is shown in a converted, encoded format 1815, highly compressed, reducing the example data from 96 bits of data, to 12 bits of data, before sending this newly encoded data through the process again 1820, to be encoded by a second library 1825, reducing it even further. The newly converted data 1830 is shown as only 6 bits in this example, thus a size of 6.25% of the original data packet. With recursive encoding, then, it is possible and implemented in the system to achieve increasing compression ratios, using multi-layered encoding, through recursively encoding data. Both initial encoding libraries 1810 and subsequent libraries 1825 may be achieved through machine learning techniques to find optimal encoding patterns to reduce size, with the libraries being distributed to recipients prior to transfer of the actual encoded data, such that only the compressed data 1830 must be transferred or stored, allowing for smaller data footprints and bandwidth requirements. This process can be reversed to reconstruct the data. While this example shows only two levels of encoding, recursive encoding may be repeated any number of times. The number of levels of recursive encoding will depend on many factors, a non-exhaustive list of which includes the type of data being encoded, the size of the original data, the intended usage of the data, the number of instances of data being stored, and available storage space for codebooks and libraries.

Additionally, recursive encoding can be applied not only to data to be stored or transmitted, but also to the codebooks and/or libraries, themselves. For example, many installations of different libraries could take up a substantial amount of storage space. Recursively encoding those different libraries to a single, universal library would dramatically reduce the amount of storage space required, and each different library could be reconstructed as necessary to reconstruct incoming streams of data.

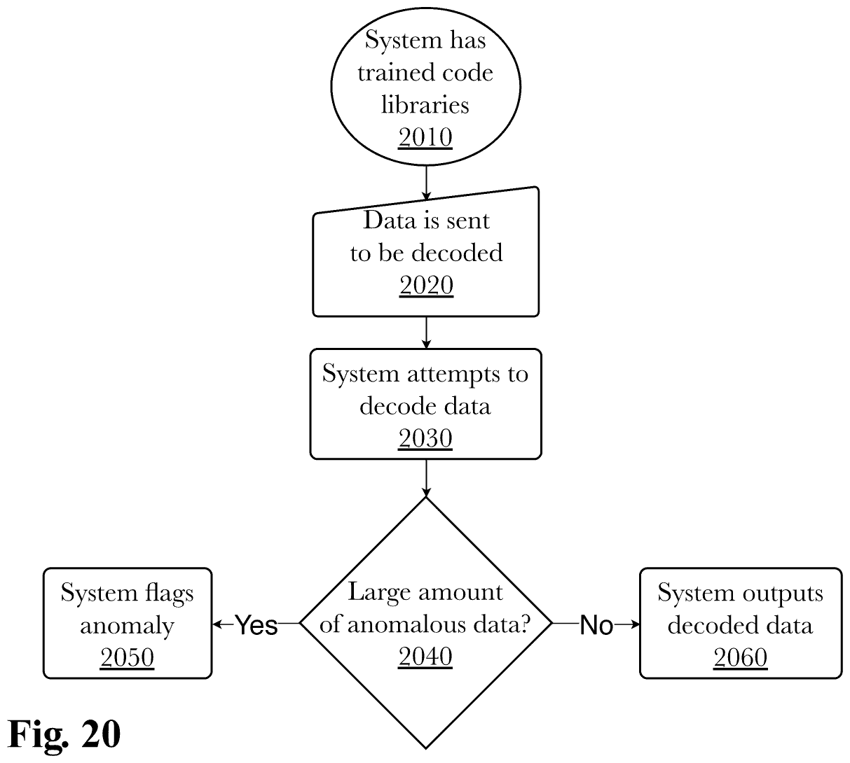

FIG. 20 is a flow diagram of an exemplary method used to detect anomalies in received encoded data and producing a warning. A system may have trained encoding libraries 2010, before data is received from some source such as a network connected device or a locally connected device including USB connected devices, to be decoded 2020. Decoding in this context refers to the process of using the encoding libraries to take the received data and attempt to use encoded references to decode the data into its original source 2030, potentially more than once if recursive encoding was used, but not necessarily more than once. An anomaly detector 1910 may be configured to detect a large amount of un-encoded data 2040 in the midst of encoded data, by locating data or references that do not appear in the encoding libraries, indicating at least an anomaly, and potentially data tampering or faulty encoding libraries. A flag or warning is set by the system 2050, allowing a user to be warned at least of the presence of the anomaly and the characteristics of the anomaly. However, if a large amount of invalid references or unencoded data are not present in the encoded data that is attempting to be decoded, the data may be decoded and output as normal 2060, indicating no anomaly has been detected.

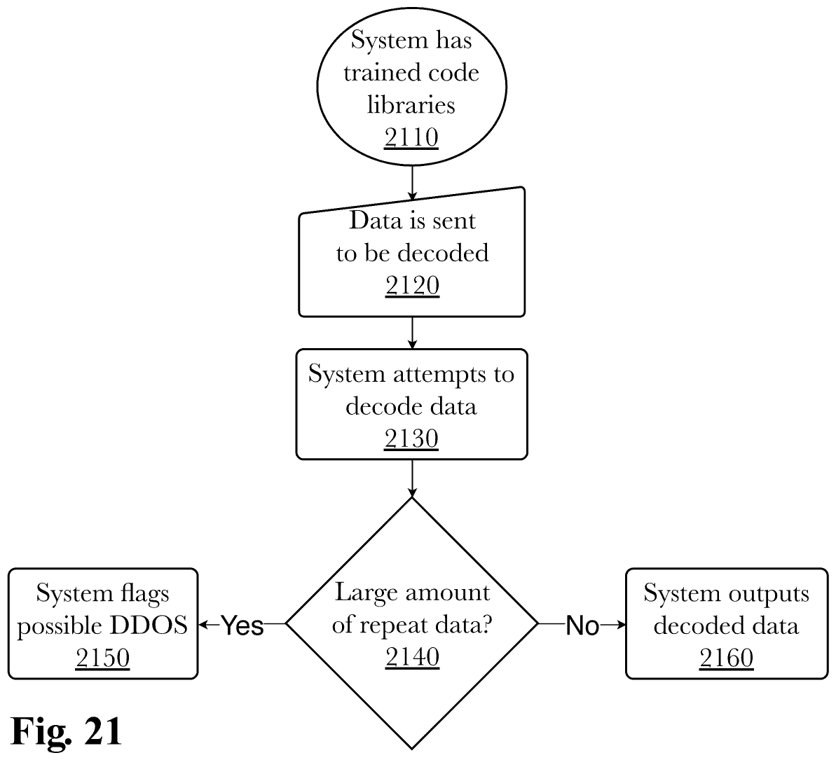

FIG. 21 is a flow diagram of a method used for Distributed Denial of Service (DDoS) attack denial. A system may have trained encoding libraries 2110, before data is received from some source such as a network connected device or a locally connected device including USB connected devices, to be decoded 2120. Decoding in this context refers to the process of using the encoding libraries to take the received data and attempt to use encoded references to decode the data into its original source 2130, potentially more than once if recursive encoding was used, but not necessarily more than once. A DDOS detector 1920 may be configured to detect a large amount of repeating data 2140 in the encoded data, by locating data or references that repeat many times over (the number of which can be configured by a user or administrator as need be), indicating a possible DDOS attack. A flag or warning is set by the system 2150, allowing a user to be warned at least of the presence of a possible DDOS attack, including characteristics about the data and source that initiated the flag, allowing a user to then block incoming data from that source. However, if a large amount of repeat data in a short span of time is not detected, the data may be decoded and output as normal 2160, indicating no DDOS attack has been detected.

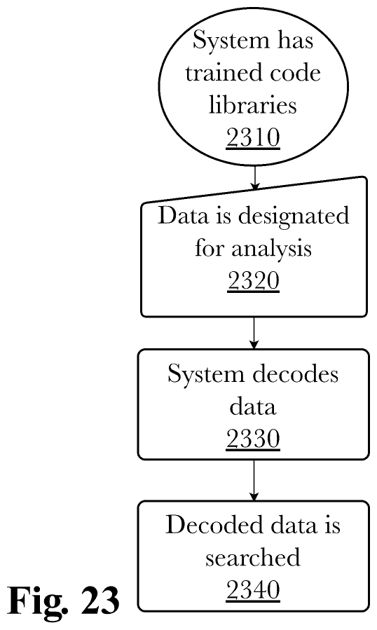

FIG. 23 is a flow diagram of an exemplary method used to enable high-speed data mining of repetitive data. A system may have trained encoding libraries 2310, before data is received from some source such as a network connected device or a locally connected device including USB connected devices, to be analyzed 2320 and decoded 2330. When determining data for analysis, users may select specific data to designate for decoding 2330, before running any data mining or analytics functions or software on the decoded data 2340. Rather than having traditional decryption and decompression operate over distributed drives, data can be regenerated immediately using the encoding libraries disclosed herein, as it is being searched. Using methods described in FIG. 9 and FIG. 11, data can be stored, retrieved, and decoded swiftly for searching, even across multiple devices, because the encoding library may be on each device. For example, if a group of servers host codewords relevant for data mining purposes, a single computer can request these codewords, and the codewords can be sent to the recipient swiftly over the bandwidth of their connection, allowing the recipient to locally decode the data for immediate evaluation and searching, rather than running slow, traditional decompression algorithms on data stored across multiple devices or transfer larger sums of data across limited bandwidth.

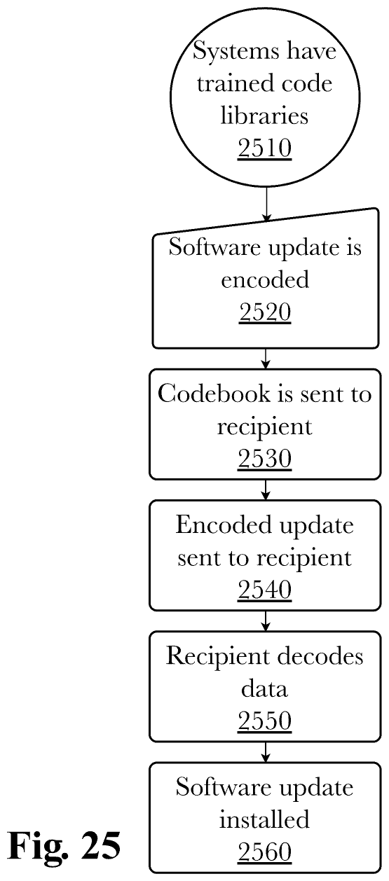

FIG. 25 is a flow diagram of an exemplary method used to encode and transfer software and firmware updates to a device for installation, for the purposes of reduced bandwidth consumption. A first system may have trained code libraries or “codebooks” present 2510, allowing for a software update of some manner to be encoded 2520. Such a software update may be a firmware update, operating system update, security patch, application patch or upgrade, or any other type of software update, patch, modification, or upgrade, affecting any computer system. A codebook for the patch must be distributed to a recipient 2530, which may be done beforehand and either over a network or through a local or physical connection, but must be accomplished at some point in the process before the update may be installed on the recipient device 2560. An update may then be distributed to a recipient device 2540, allowing a recipient with a codebook distributed to them 2530 to decode the update 2550 before installation 2560. In this way, an encoded and thus heavily compressed update may be sent to a recipient far quicker and with less bandwidth usage than traditional lossless compression methods for data, or when sending data in uncompressed formats. This especially may benefit large distributions of software and software updates, as with enterprises updating large numbers of devices at once.

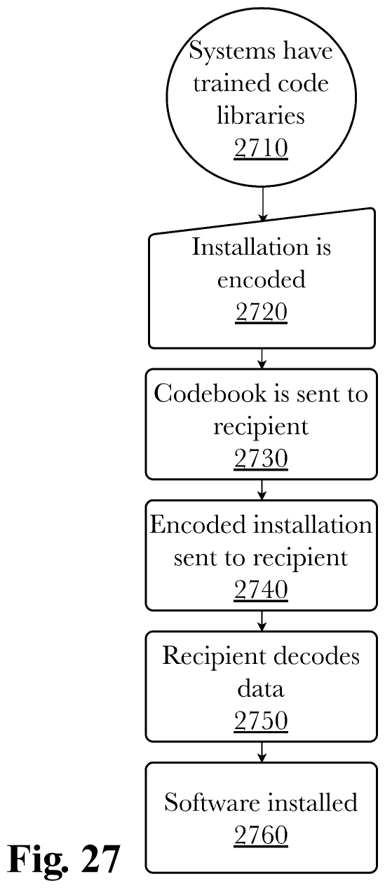

FIG. 27 is a flow diagram of an exemplary method used to encode new software and operating system installations for reduced bandwidth required for transference. A first system may have trained code libraries or “codebooks” present 2710, allowing for a software installation of some manner to be encoded 2720. Such a software installation may be a software update, operating system, security system, application, or any other type of software installation, execution, or acquisition, affecting a computer system. An encoding library or “codebook” for the installation must be distributed to a recipient 2730, which may be done beforehand and either over a network or through a local or physical connection, but must be accomplished at some point in the process before the installation can begin on the recipient device 2760. An installation may then be distributed to a recipient device 2740, allowing a recipient with a codebook distributed to them 2730 to decode the installation 2750 before executing the installation 2760. In this way, an encoded and thus heavily compressed software installation may be sent to a recipient far quicker and with less bandwidth usage than traditional lossless compression methods for data, or when sending data in uncompressed formats. This especially may benefit large distributions of software and software updates, as with enterprises updating large numbers of devices at once.

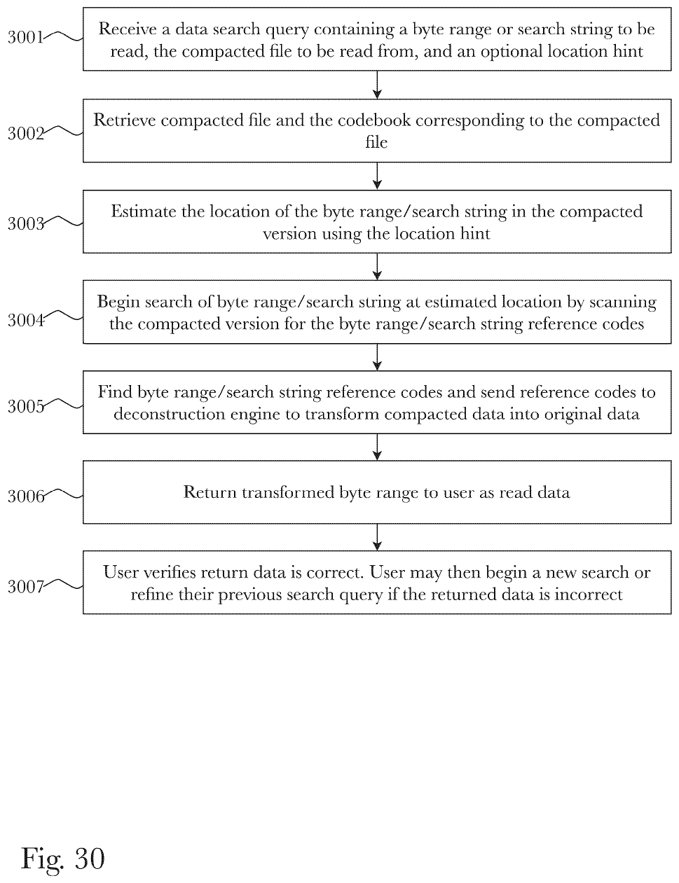

FIG. 30 is a flow diagram of an exemplary method used to search and read data from a compacted data file. For the purposes of this example drawing only, the original file is an ASCII (text) file, however, it should be understood that this method is applicable across a broad range of data types and formats. A data search query comprising a byte range or search string to be searched for and read, a compacted file to be read from, and an optional location hint from which to begin the search 3001 is received by the system. The data search query is parsed and both the compacted data file and its corresponding codebook is retrieved 3002. If a location hint was provided in the data read query, then an estimated location within the compacted version is generated using the location hint 3003. The location hint may include, but is not limited to a single byte location, a guess such as “start at the 60% mark”, and a search operator such (e.g. “near”, “not”, etc.). The next step begins to search for the byte range/search word at the estimated location by scanning the compacted version for the byte range/search string reference codes 3004. This step may find the starting bit location that corresponds with the beginning of the search term (i.e. byte range, search string) and retrieve a plurality of bits beginning with the starting bit, the plurality of bits represent the compacted version of the search term. The search may be done via a binary search starting from the estimated location. The search step may further involve in generating at least one or more possible sets of encodings for the search string, creating a search pair by concatenating encodings from the same set, and then searching for the search pair within the compacted data file. Once the byte range/search string has been located, its reference codes are sent to a deconstruction engine to transform the compacted data into its original form 3005. The transformed data is returned to the user as read data 3006. The user may then verify that the returned data is correct and can begin a new query process 3007.

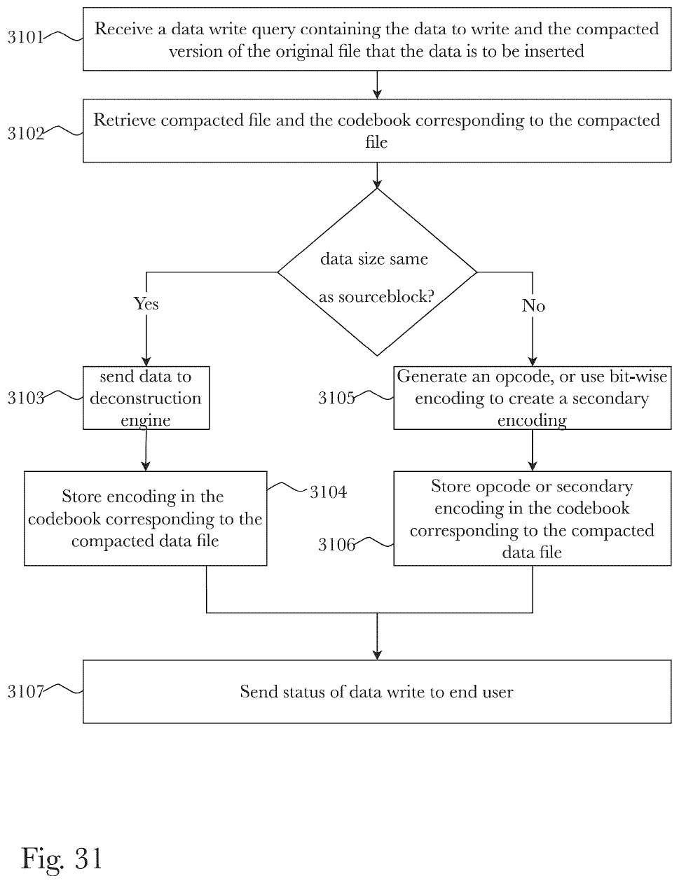

FIG. 31 is a flow diagram of an exemplary method used to write data to a compacted data file. The process begins when a data write query is received by the system, the data write query may be comprised of a write term (data to write) and an identified compacted data file that the write term is to be inserted into 3101. Then, the identified compacted data file and the codebook corresponding to the compacted data file is retrieved 3102. Next, the length of the write term to be inserted is checked and compared against the length of the sourceblock. If the data is the same size as the sourceblock then it can simply be encoded 3103 and stored within the codebook corresponding to the compacted data file 3104. If the data is not the same size as the sourceblock, then the system may generate an opcode or use bit-wise encoding to create a secondary encoding 3105. Writing a data file that is larger than the sourceblock can modify the output of codewords globally. To counter this, an opcode may be generated that accounts for the newly inserted data. The opcode can alert the decoder to apply an offset when decoding, thus accounting for the insertion of data into the original data file. In another embodiment, instead of using an opcode, unused bits in the codebook are used to indicate a secondary encoding. A secondary encoding indicates that data was inserted into a file, and that at the next location there are two or more possible encodings. If such a bit is encountered it means there is a secondary encoding coming up, and the encoder can switch to secondary encoding, encode one fewer byte, and then resume encoding as before. In this way there is no need to apply an offset, just use existing extra bits to create secondary encodings which prevents having to re-encode the entire original file including the inserted data. The generated opcode or the encoded bits are stored within the codebook corresponding to the compacted data file 3106. A confirmation of a successful data write process is sent to the end user 3107.

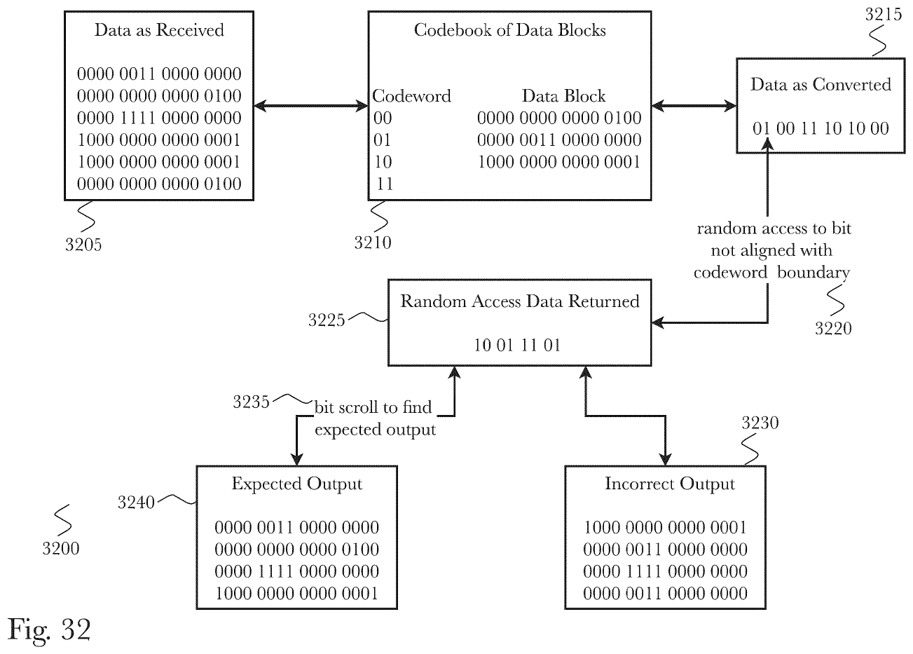

FIG. 32 is a diagram showing an example of how data might be converted into reference codes, how the converted data randomly accessed may result in incorrect output, and how correct data may be located, according to an embodiment 3200. As data is received 3205, it is read by the processor in sourceblocks of a size dynamically determined by the previously disclosed sourceblock size optimizer 410. In this example, each sourceblock is 16 bits in length, and the codebook 3210 initially contains three sourceblocks with codewords 00, 01, and 10. The entry for codeword 11 is initially empty. As each 16 bit sourceblock is received, it is compared with the codebook. If that sourceblock is already contained in the codebook, it is assigned the corresponding codeword. So, for example, as the first line of data (0000 0011 0000 0000) is received, it is assigned the codeword (01) associated with that sourceblock in the codebook. If that sourceblock is not already contained in the codebook, as is the case with the third line of data (0000 1111 0000 0000) received in the example, that sourceblock is added to the codebook and assigned a codeword, in this case 11. The data is thus converted 3215 to a series of codewords to sourceblocks in the codebook. The data is stored as a collection of codewords, each of which contains the codeword to a sourceblock and information about the location of the sourceblocks in the data set. Reconstructing the data is performed by reversing the process. Each stored codeword in a data collection is compared with the codewords in the codebook, the corresponding sourceblock is read from the codebook, and the data is reconstructed into its original form.

A data search query specifying a search term to read from the original data set. In this example, the selected search term captures to the first four lines of the data as received 3205. The system estimates a bit location N′ in the converted data set that corresponds to byte N in the original data set. The estimated location, bit N′, may not be aligned with a codeword boundary 3220. In this example, the first codeword that should be accessed and returned is supposed to be 01, but the estimate N′ location puts the pointer at the last bit in the codeword 3220. When N′ is not aligned with a codeword boundary, the system will start decoding in the middle of a codeword, resulting in returned data 3225 that when decoded leads to incorrect output 3230. Due to the boundary misalignment, the random access data returned is 10 01 11 01 3225, when the correct random access data returned should have been 01 00 11 10. The user that submits the data search query will receive the incorrect output and recognize it as garbage output. The user can manually bit scroll 3235 forward and backward from N′ until a codeword boundary is found and the expected output 3240 corresponding to the search term is returned.

In another embodiment, mile markers are stored in a file accompanying the compacted data set with a list of exact locations N′ in the compacted data set that correspond to N=100, 200, 1000, etc. The mile marker file enables more refined estimates of N′ with less seeking necessary as now the user may seek forwards and backwards in the compacted data set in codeword increments and boundary alignment is automatic. These mile markers (i.e. locations) might denote which bit corresponds to the 1000^{th} byte from the unencoded data, which bit corresponds to the 2000^{th} byte, etc. The use of mile markers prevents the possibility of starting the data read process in the middle of codeword as any search may begin at the nearest mile marker bit associated with byte N.

FIG. 33 is a diagram showing an exemplary process of parsing a search term using multiple encodings, according to an embodiment. In this example, the search term is a search string. The original data file was divided into sourceblocks, and the size of these sourceblocks are referred to as the sourceblock length. A search string may be reasonably long compared to the sourceblock length, such as two or three times the sourceblock length. There may be multiple possible encodings of the search string that occur, because the sourceblock might not be aligned to a boundary of the search string. For example, the if the search string was “AtomBeam” 3301 and the sourceblock length is three bytes, there may be three separate encodings 3300, 3310, 3320 of the search string. The first encoding 3300 of the search string may be “Ato” 3302, “mBe” 3303, and “amx” 3304 where “x” is something that is not relevant to the search string. The second encoding 3310 may be “tom” 3311, “Bea” 3312, and “mxy” 3313 where “x” and “y” are not relevant to the search string. The third 3320 encoding may be “omB” 3321, “cam” 3322, and “xyz” 3323 where “xyz” is not relevant to the search string. The data search engine 2940 may generate the encoding for each search string using the codebook corresponding to the compacted data file to assign a codeword to each sourceblock.

The compacted data file may then be searched for occurrences of the assigned codeword(s). For example, the “Ato” 3302 and “mBe” 3303 sourceblocks may each be encoded with codewords C1 3305 and C2 3306 respectively. These sourceblocks 3302, 3303 were selected because they both contain only data that is part of the search string 3301 and do not contain non relevant data (e.g. “x”, “xy” “xyz” from preceding paragraph). The assigned codewords may be concatenated to form a codeword double (pair) C1C2 3307 and then the search engine 2940 may perform a search for codeword pair C1C2 3307 in the compacted data. This process is done for each of the possible encodings 3300, 3310, 3320 of the search string 3301.

From encoding two 3310 sourceblocks containing “tom” 3311 and “Bea” 3312 are assigned a codeword such as C3 3314 and C4 3315. These codewords may be concatenated to form a codeword pair C3C4 3316 and then the search engine 2940 may perform a search for the codeword pair C1C2 3316 in the compacted data file. Likewise, from encoding three 3320 sourceblocks containing “omB” 3321 and “cam” 3322 are assigned a codeword such as C5 3324 and C6 3325. These codewords may be concatenated to form a codeword pair C5C6 3326 and then the search engine 2940 may perform a search for the codeword pair C5C6 3326 in the compacted data file. Each of the codeword pairs C1C2 3307, C3C4 3316, and C5C6 3326 form three new search strings and the data search engine 2940 may scan through the compacted data file looking for all three of them. If any of them are found, then the codewords in the compacted data file to the left and right of the found codeword pair may be decoded to identify if the correct letter (byte) is preceding or following the codeword pair. In this example, two source blocks were used to create a codeword pair, however, it should be appreciated that number of sourceblocks concatenated is dependent upon the length of the search term and the sourceblock length. There may be codeword triples, codeword quadruples, etc., as any codeword n-tuple may be possible due to the above mentioned dependencies.

For example, if the search results return “tomBea” that means an occurrence of codeword pair C3C4 3316 was found. The search engine 2940 may decode one letter to the left side and check if it is “A” and one letter to the right to check if is “m”. If those are the letters found the search string has been located, if not then it is not the correct string and the scan continues through the compacted data file until another occurrence of any one of the codeword pairs 3307, 3316, or 3326 is found. The data search engine 2940 performs this process automatically until the search string has been located or the entire compacted data file has been scanned and searched.

### Hardware Architecture

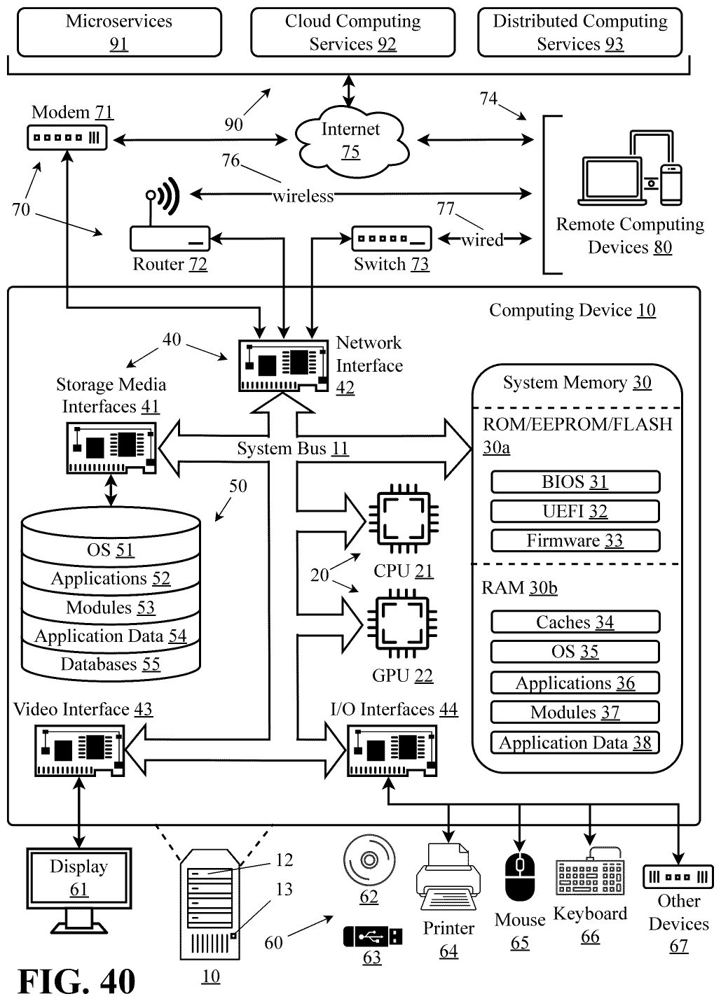

FIG. 40 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry

Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks;

processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IOT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A system for adaptive random access with learned query optimization for compacted data files, comprising:
a computing device comprising a memory, a processor, and a non-volatile data storage device;
a learned access pattern store comprising data representing historical query patterns and user behavior models;
a random access engine comprising a plurality of programming instructions stored in the memory and operating on the processor, wherein the plurality of programming instructions, when operating on the processor, cause the computing device to:
receive a data search query for a compacted data file;
retrieve learned pattern data from the learned access pattern store corresponding to the data search query;
optimize at least one random access parameter based on the learned pattern data; and
execute the data search query using the optimized random access parameter to locate data within the compacted data file; and
a learning feedback system comprising a plurality of programming instructions stored in the memory and operating on the processor, wherein the plurality of programming instructions, when operating on the processor, cause the computing device to:
monitor query execution results; and
update the learned access pattern store based on the query execution results.

2. The system of claim 1, wherein the random access engine further comprises an adaptive estimator module that optimizes location estimation by:
calculating a base mathematical estimate for a location hint in the data search query;
retrieving pattern-based adjustment factors from the learned access pattern store based on similar historical queries; and
generating an optimized location estimate by combining the base mathematical estimate with the pattern-based adjustment factors.

3. The system of claim 1, wherein the random access engine further comprises a predictive boundary detector that optimizes codeword boundary detection by:
analyzing bit sequences at an estimated location using learned codeword pattern models from the learned access pattern store;
applying statistical pattern matching to identify codeword boundaries; and
outputting refined boundary locations with associated confidence scores.

4. The system of claim 1, wherein the at least one random access parameter comprises search strategy selection, and wherein the random access engine optimizes search strategy selection by:
analyzing characteristics of the data search query;
retrieving historical success rates for different search strategies from the learned access pattern store; and
selecting an optimal search strategy based on the query characteristics and historical success rates.

5. The system of claim 1, further comprising a dynamic codebook optimizer that:
analyzes sourceblock access frequencies from the learned access pattern store;
identifies frequently accessed sourceblocks based on access frequency thresholds; and
reorganizes a reference codebook by relocating the frequently accessed sourceblocks to positions that minimize access latency.

6. The system of claim 5, wherein the dynamic codebook optimizer further implements hierarchical reference codes by assigning shorter reference codes to the frequently accessed sourceblocks based on actual access patterns.

7. The system of claim 1, further comprising an enhanced search cache that:
generates predictions of likely future queries based on current query context and learned access patterns;
calculates confidence scores for the predictions; and
proactively loads predicted data when system resources permit.

8. The system of claim 1, wherein the learned pattern data comprises:
user behavior patterns indicating query sequences and preferences;
temporal access patterns indicating time-based variations in data access; and
co-occurrence data indicating which data elements are frequently accessed together.

9. The system of claim 1, wherein the learning feedback system further:
tracks prediction accuracy for optimized random access parameters;
applies temporal decay weighting to emphasize recent query patterns over historical data; and
validates learning results against system performance metrics before updating the learned access pattern store.

10. The system of claim 1, wherein the random access engine optimizes multiple random access parameters simultaneously, the random access parameters comprising location estimation accuracy, boundary detection precision, and search strategy effectiveness.

11. A method for adaptive random access with learned query optimization for compacted data files, comprising the steps of:
receiving a data search query for a compacted data file;
retrieving learned pattern data from a learned access pattern store corresponding to the data search query;
optimizing at least one random access parameter based on the learned pattern data;
executing the data search query using the optimized random access parameter to locate data within the compacted data file;
monitoring query execution results; and
updating the learned access pattern store based on the query execution results.

12. The method of claim 11, further comprising the steps of:
calculating a base mathematical estimate for a location hint in the data search query;
retrieving pattern-based adjustment factors from the learned access pattern store based on similar historical queries; and
generating an optimized location estimate by combining the base mathematical estimate with the pattern-based adjustment factors.

13. The method of claim 11, further comprising the steps of:
analyzing bit sequences at an estimated location using learned codeword pattern models from the learned access pattern store;
applying statistical pattern matching to identify codeword boundaries; and
outputting refined boundary locations with associated confidence scores.

14. The method of claim 11, wherein the at least one random access parameter comprises search strategy selection, and further comprising the steps of:
analyzing characteristics of the data search query;
retrieving historical success rates for different search strategies from the learned access pattern store; and
selecting an optimal search strategy based on the query characteristics and historical success rates.

15. The method of claim 11, further comprising the steps of:
analyzing sourceblock access frequencies from the learned access pattern store;
identifying frequently accessed sourceblocks based on access frequency thresholds; and
reorganizing a reference codebook by relocating the frequently accessed sourceblocks to positions that minimize access latency.

16. The method of claim 15, further comprising the step of implementing hierarchical reference codes by assigning shorter reference codes to the frequently accessed sourceblocks based on actual access patterns.

17. The method of claim 11, further comprising the steps of:
generating predictions of likely future queries based on current query context and learned access patterns;
calculating confidence scores for the predictions; and
proactively loading predicted data when system resources permit.

18. The method of claim 11, wherein the learned pattern data comprises:
user behavior patterns indicating query sequences and preferences;
temporal access patterns indicating time-based variations in data access; and
co-occurrence data indicating which data elements are frequently accessed together.

19. The method of claim 11, further comprising the steps of:
tracking prediction accuracy for optimized random access parameters;
applying temporal decay weighting to emphasize recent query patterns over historical data; and
validating learning results against system performance metrics before updating the learned access pattern store.

20. The method of claim 11, wherein optimizing at least one random access parameter comprises optimizing multiple random access parameters simultaneously, including location estimation accuracy, boundary detection precision, and search strategy effectiveness.
